(19) United States
(12) Patent Application Publication
(10) Pub. No.: US 2008/0114705 A1
(43) Pub. Date: May 15, 2008

(54) Springing real estate mortgage investment conduit

(76) Inventors: Nancy De Liban, Studio City, CA (US); Schloessmann W. Michael, Glendale, CA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/598,831

(22) Filed: Nov. 14, 2006

(51) Int. Cl. G06Q 40/00

(52) U.S. Cl. 705/36 T

(57) ABSTRACT

A method and combination which allow Real Estate Investment Trust (REIT) issuers to issue Mortgage-Backed Securities (MBS) via a trust structure while allowing non-REIT entities to finance the equity portion of the deal are provided. An upfront solution is provided to address the traditional constraints of equity financing under a Real Estate Investment Trust (REIT) exemption of the Taxable Mortgage Pool (TMP) when a Taxable Mortgage Pool (TMP) triggering event takes place so that the trust becomes a REMIC, thereby allowing non-REIT financing entity to sell the equity components.

### FIELD OF THE INVENTION

The present invention finds application in the structured finance industry, and generally in the field of mortgage-backed securities (MBS) and asset backed securities (ABS). In particular, the present invention provides a solution for avoiding traditional constraints in financing the equity of the owners trust securitization that utilizes time tranching due to the risk of loosing favorable tax treatment under a Real Estate Investment Trust (REIT) exemption of the Taxable Mortgage Pool (TMP) regulations.

### BACKGROUND OF THE INVENTION

Securitization is the process of converting various types of assets with limited liquidity into liquid and marketable securities. It is a financial tool that has become vastly popular among financial institutions and corporations. It enables banks to free up regulatory capital, corporations to raise capital more cheaply and institutional investors to have access to highly rated securities with very competitive returns.

Almost any kind of asset can be securitized. Popular candidates for securitization include trade receivables, credit card balances, consumer loans, lease receivables, automobile loans, and other consumer and business receivables. In fact, any financial asset which entitles its holder to receive a specified stream of payments may be suitable for securitization. The assets most commonly securitized by dollar volume are single family residential mortgage loans. One of the reasons for securitization of mortgage loans is that securitization provides a vehicle for transforming relatively non-liquid, individual financial assets into liquid and tradable capital market instruments. Generally, the principle and interest payment on the issued securities are based on the collections received from the financial assets.

The basic securitization transaction typically involves a transfer of financial assets from the owner to a securitization entity which issues the securities to investors. That is, there are usually four key parties to a securitization transaction:
1) an entity which issues the securities for the assets;
2) an investor who wants to acquire the securities backed by the payments to be collected on the assets;
3) a transferor that is the owner of the assets; and
4) in some transactions, a credit support provider that guarantees payments to investors and thereby uses its credit to enhance the credit quality of the assets or securities backed by such assets.

As explained by the U.S. Securities and Exchange Commission (SEC), mortgage-backed securities (MBS) are debt obligations that represent claims to the cash flows from pools of mortgage loans, most commonly on residential property. Mortgage loans are purchased from banks, mortgage companies, and other originators and then assembled into pools by a governmental, quasi-governmental, or private entity. The entity then issues securities that represent claims on the principal and interest payments made by borrowers on the loans in the pool, a process known as securitization. MBSs exhibit a variety of structures. The most basic types are pass-through participation certificates, which entitle the holder to a pro-rata share of all principal and interest payments made on the pool of loan assets. See “Mortgage-Backed Securities,” http://www.sec.gov/answers/mortgagesecurities.htm, (Modified: Feb. 11, 2003).

For example, an entity such as a brokerage firm or a bank, can issue mortgage-backed securities which represent an undivided beneficial ownership interest in a group or pool of one or more mortgages. In this regard, the mortgage-backed security process begins with a mortgage loan. The loan is made by a financial institution or other lender to a borrower to finance or refinance the purchase of a home or other property. These loans are made to borrowers under varying terms (for example, 15-year, 30-year, fixed-rate, adjustable-rate, and so on). During the life of the loan, the balance is generally amortized, or reduced, until it is paid off. The borrower usually repays the loan in monthly installments that typically include both principal and interest. Because mortgage loans may take years to pay off, lenders must find ways to replenish their funds in order to make more mortgage loans. To do this, lenders sell groups of mortgages with similar characteristics into the secondary mortgage market to issuers or guarantors of mortgage-backed securities. The entity pools loans that generally conform to certain standards and converts them into single-class mortgage-backed securities, which the entity then guarantees as to timely payment of principal and interest. See “Basics of Fannie Mae MBS,” http://www.fanniemae.com/mbs/mbsbasics/index.jhtml?p=Mortgage-Backed+Securities&s=Basics+of+Fannie+Mae+MBS, (Last Revised: Oct. 28, 2005)

Securitization transactions can also create multiple classes of securities. Creating multiple classes of securities gives more flexibility in terms of the ability to sell the securities to different levels of investors. A “tranche” (from the French, meaning “slice”) in the context of a securitization, refers to one class of securities issued in a transaction that created multiple classes issued simultaneously. For example, in a deal that uses a senior/subordinate structure, the senior and subordinate classes are the tranches of the deal. Such a deal is described as using “credit tranching.” Another example is “time tranching” which applies to sequential pay structures where most senior classes are paid first and the most subordinate classes are paid last.

From a tax standpoint, the primary concern with asset securitization is the tax treatment of the entity which issues the securities. In this regard, an important consideration is that the entity which issues the securities not be subject to double-taxation: a corporate level tax and tax on distributions received by the security holders. That is, the entity should be “transparent” from a tax perspective.

As described in detail in Kenneth G. Lore and Cameron L Cowan, “Mortgage-Backed Securities,” West's Securities Law Handbook Series (2004), the entire contents of which are hereby incorporated by reference, when structuring securities backed by pools of mortgages, tax considerations arise under Treasury regulations issued under Code Section 7701(i) (the “TMP regulations”), which provide guidance for determining whether an entity is a taxable mortgage pool. In particular, TMP regulations provide that the purpose of the taxable mortgage pool rules is to prevent income generated by a pool of real estate mortgages from escaping Federal Income taxation when the pool is used to issue multiple class mortgage-backed securities.

A type of entity which is transparent from the perspective of the TMP regulations is a trust which meets two key criteria: fixed investments and a prohibition against the equity of a trust being owned by more than one entity. With regard to the fixed investment requirement, in order to receive the treatment as a trust, rather than a corporation, the trust agreement cannot confer upon the trustee or some other party a power to vary the investment of the certificate holders. With regard to the multiple classes of ownership requirement, the TMP regulations ordinarily classify a trust with multiple classes of beneficial ownership as an association taxable as a corporation or a partnership.

An example of an entity that may be deemed transparent from a tax perspective under the TMP regulations is an owner trust that is formed as a trust under state law where a transferor contributes or sells the assets to the owner trust and takes in return equity interests in the owner trust represented by the trust certificates plus cash. The owner trust issues its debt instruments to investors and uses the proceeds to provide the consideration for the transfer of the assets from the transferor. The transferor then either retains the trust certificates or sells them to other investors. The owner trust holds the assets and uses cash flow from the assets to service the debt. That is, the owner trust issues two classes of securities: (i) debt instruments, and (ii) trust certificates.

One of the basic principles of federal income tax law is that the substance of a transaction rather than its form governs the treatment of the transaction under the federal income tax laws. Accordingly, if an owner trust, in substance, is no different than an investment trust with multiple classes of ownership, then it could conceivably be treated by the IRS as an association taxable as a corporation or a partnership. To prevent such a characterization, the transaction is structured so that its substance is viewed as a debt financing. This requires that owner trust have substantial and continuing economic rights in the assets.

Thus, within a conventional owner trust structure, debt-for tax, rather than sale-for tax, transactions are performed. Debt-for tax transactions are a type of securitization in which the issuer is not treated as having sold the assets which are used to secure the debt issued but rather borrowed the money. A debt-for tax transaction does not give rise to any gain or loss for tax purposes. However, there are limitations on such transaction that must be met in order to avoid creating a TMP subject to a corporate level taxation. One of the limitations is that time-tranching is not available if the corporate level taxation of the TMP is to be avoided. Another limitation is that multiple classes of debt are allowed only if paid pro rata. That is, while senior and subordinate bonds are permitted, the principle payments to all the bond holders, senior and subordinate, must be made pro rata so that only the losses may be allocated to subordinate bonds first. In other words, a structure having multiple classes of debt with different maturity where senior bonds are paid down first and subordinate bonds after, i.e., sequentially (as in time-tranching) is not permitted.

Thus, such a structure is considered inferior to a structure which permits, for example multiple classes of debt with time-tranching, because the economics afforded through the multiple class time-tranched transactions are typically more flexible than can be achieved with single class debt transactions. That is, economic advantage is due to the issuer being able to take advantage of the yield curve and issue bonds that have a shorter average life, while greater flexibility is due to a greater investment base that can be achieved by customizing the bond to meet specific investors' desire to have a shorter average life bond.

So, the trade-off of the owner trust structure is that, while debt-for tax transactions are available, the structuring flexibility is not. Accordingly, while the owner trust structures provide certain tax advantages by having debt-for tax transactions, they afford limited flexibility to, for example, time-tranche which is available in a sales-for tax transaction. See “Common Terms In Structured Finance”, Thacher Proffitt, www.tpw.com (2006).

In 1960, the U.S. Congress amended the tax laws to create a real estate investment trust (REIT), and in the Tax Reform Act (TRA) of 1986 permitted the creation of real estate mortgage investment conduits (REMICs), which were designed to alleviate some of the above-noted drawbacks of the then available financing vehicles. See James M. Peaslee and David Z. Nirenberg, “Federal Income Taxation of Securitization Transactions”, Third Edition, Published by Frank J. Fabozzi Associates (2001), the entire content of which is hereby incorporated by reference.

Real Estate Mortgage Investment Conduit (REMIC)

TRA of 1986 permitted the creation of real estate mortgage investment conduits (REMICs) which were designed to alleviate some of the above-noted drawbacks of the then available financing vehicles, including REITs and owner trusts. Thus, effective for mortgage pools created on or after Jan. 1, 1992, and for mortgage pools to which substantial assets are transferred on or after Jan. 1, 1992, REMICs are virtually the only non-taxable vehicles capable of issuing multi-class securities with staggered maturity (time-tranched) secured by REMIC eligible assets as defined by the TRA of 1986. REMIC eligible assets primarily include qualified mortgages which are obligation principally secured by interest in real property. Today, the REMIC structure is the most common vehicle for issuing mortgage-backed securities.

Thus, the REMIC structure is used when the parties want to achieve more flexibility in structuring the cash flows from the secured assets to meet investor demands and obtain a more beneficial economic execution, while avoiding corporate level taxation under TMP regulations. That is, REMIC regulations allow securitization of mortgage loans via creation of new entities that are exempt from corporate level taxation. The new entities are treated as transparent entities for tax purposes where the security holders are paying taxes on the distributions. There is a requirement in making a REMIC election that the transfer of the loans itself be treated for tax purposes, so that the sponsor of the transfer would be deemed to have sold those loans for tax purposes, as opposed to having performed a debt-for tax transaction. Accordingly, there may be a tax associated with what the sponsors execute on the sale transaction (based on the sponsor's tax basis). However, after that transaction, the REMIC entity is free from corporate level taxation—it is treated as a transparent entity. Therefore, making a REMIC election is very advantageous for tax purposes by avoiding double taxation.

Referring to FIG. 9, an example of a REMIC structure is describe as follows. HHL 20 sells whole loan residential mortgage pool to a taxable (rather than “qualified” as in the owner trust structure example described below with reference to FIG. 8) REIT subsidiary (“TRS”) 21. It is to be noted that, while a REIT and a TRS are shown herein as bond holders, one of ordinary skill in the art would readily appreciate that other entities can be utilized. The TRS 21 sells whole loans to the Depositor 23. Transfer of whole loans to the Depositor 23 would be treated as a sale for tax purposes. The Depositor 23 deposits the mortgage loans into the Asset-Backed Certificates Trust (“Trust”) 26 and the Trust 26 issues senior and subordinate REMIC certificates to the Depositor 23. The Depositor 23 transfers to the REIT 24 a portion, or all, of the subordinate certificates to be retained by the REIT 24. Depositor 23 delivers the REMIC certificates to be sold to the Securities Corporation (“SC”) 22 pursuant to an underwriting agreement. The SC 22 sells senior, and/or subordinate, certificates to the ABS investors 25 and delivers net proceeds to the Depositor 23.

Real Estate Investment Trust (REIT)

As described in detail in Chan Su Han et al., “Real Estate Investment Trusts,” Oxford University Press (2003), the entire contents of which are hereby incorporated by reference, in 1960, the U.S. Congress amended the tax laws to create a real estate investment trust (REIT) as an investment vehicle for the express purpose of providing investors with an opportunity to invest in real properties and, at the same time, to enjoy the same benefits provided to shareholders in investment trusts.

A traditional REIT is a fund created exclusively for holding real properties, mortgage-related assets, or both. In order to make REITs a more attractive investment, Congress waived the corporate-level income tax on REITs if they met certain conditions set by tax laws governing them. Subsequently, in the Tax Reform Act of 1976, and still further in the Tax Reform Act of 1986, Congress allowed REITs more flexibility to deal with changing economic condition, thus reducing the likelihood that a REIT would inadvertently lose its tax status because of a failure to meet strict qualification requirements. These requirements were modified still further in the Taxpayer Relief Act of 1997 and the REIT Modernization Act of 1999. While the tax laws governing REITs have changed significantly since Congress has created the REIT industry in 1960, the REIT has remained a liquid and fungible real estate investment vehicle characterized by the absence of the double-taxation of income. That is, under the REIT exemption to the TMP regulations, by utilizing an owner trust structure, a debt-for tax treatment for tax purposes, as well as other regulatory advantages, can be achieved.

The limitation, however, is that the equity, which is typically the residual and the most subordinate classes, or essentially the credit support for the class of debt (having debt means having equity), must be of a certain required amount in order to receive the debt-for tax opinion. The equity must be held by a qualified REIT at all times in order to maintain the REIT exemption to the TMP regulations. If all or a portion of the equity is transferred to a non-qualifying REIT, the REIT exemption to the TMP regulations is no longer applicable, which results in (“triggers”) the imposition of corporate level tax which is in addition to the tax applicable to the distributions to holder of REIT's securities. The transfer of all or a portion of the equity to a non-qualifying REIT is an example of a “TMP triggering event”.

Referring to FIG. 8, an example of an owner trust transaction utilizing a REIT structure is described as follows. A Holder of Home Loans (“HHL”) 10 sells a whole loan residential mortgage pool to a qualified REIT subsidiary (“QRS”) 11. QRS 11 sells the whole loans to a “Depositor” 13, the sale being a “true sale” under the applicable Treasury regulations. The transfer of loans to the Depositor 13 is not be viewed under the Treasury regulations as a sale for tax purposes, but a mere facilitation of the securitization. The Depositor 13 deposits the mortgage loans into an Asset-Backed Certificates Trust (the “Trust”) 16. The Trust 16 issues senior and subordinate notes to the Depositor 13. Depositor 13 delivers: (1) owner trust certificates (“OTC”), and any subordinate and mezzanine notes required to be retained by the REIT in order to obtain the debt-for tax treatment, to REIT Holding Company (“REIT”) 14; and (2) senior notes to a Securities Corporation (“SC”) 12 pursuant to an underwriting agreement. The SC 12 sells senior notes to the ABS investors 15 and delivers proceeds, net of underwriting fee to Depositor 13. Initially, the REIT 14 may desire to also hold senior notes, and could sell them through the SC 12 at a later date, assuming equity level at that time is sufficient. The REIT 14 must hold sufficient equity, generally 4% to 6% equity in subordinated notes, to obtain a debt-for tax opinion and achieve debt-for tax treatment.

TMP Triggering Event

A TMP triggering event occurs if, for example, the entity that is holding the equity no longer qualifies under the REIT exemption to the TMP regulations. In order to avoid corporate level taxation, the equity will need to be sold to a qualified REIT buyer. If a non-qualifying buyer (for example, a buyer that does not qualify as a REIT) were to purchase the equity, a TMP triggering event would result, and the holder of the equity would have to absorb all losses, including tax consequences, first. In this regards, if a corporate level tax is imposed, it would seriously erode the economics of the equity. Thus, when selling to a non-qualifying entity, the market value of that asset drops, and very often drops significantly.

A conventional approach to dealing with a situation where equity was transferred to a non-qualifying entity under the REIT exemption of the TMP regulations, was to attempt to create a REMIC after the transfer of the equity took place. However, this approach suffered the drawbacks of undue lapse of time and expense to, among other thing, ensure the trust-holder's cooperation and obtain bond-holders' consent because this was not embedded in the origination documents.

If the REMIC elections subsequent to a TMP triggering event were not respected, and if the trust were to fail to qualify as a REIT, or if equity securities were transferred so that they were held other than by a single entity that qualified for federal income tax purposes as a REIT, directly or indirectly through one or more qualified REIT subsidiaries of such REIT or one or more entities disregarded as entities separate from such REIT or its qualified REIT subsidiaries, the trust could become subject to federal income tax as though it were a corporation. In the event that corporate federal income taxes are imposed on the trust, the cash flow available to make payments on the notes would be reduced.

Accordingly, there is a need for a solution where the contingency of various TMP triggering events taking place is addressed at the inception, so that any TMP triggering event would automatically set in motion procedures for dealing with the TMP triggering event as a matter of operation without the drawbacks discussed above.

### SUMMARY OF THE INVENTION

Exemplary embodiments of the present invention address the above-noted drawbacks by providing methods which allow Real Estate Investment Trust (REIT) issuers to issue Mortgage-Backed Securities (MBS) via, for example, an owner trust structure while allowing non-REIT entities to finance the equity portion of the deal. In the event of a TMP triggering event, the trust will automatically convert to a REMIC, thereby allowing non-REIT financing entity to sell the equity components.

According to an exemplary embodiment of the present invention, an upfront solution is provided to address the traditional constraints of equity financing under a REIT exemption of the TMP regulations when a TMP triggering event takes place.

According to exemplary embodiments of the present invention, various TMP triggering events can be addressed in a method where a trust classifiable as a TMP is created. At closing, approximately 100% of the trust certificates are acquired by at least one entity qualifying as a REIT under the TMP regulations, and at least one REMIC election is defined. So that, upon occurrence of a TMP triggering event, which causes an issuing entity to become taxable as a corporation within the meaning of the TMP regulations, the trust certificates are converted to REMIC certificates pursuant to the at least one REMIC election defined at the closing.

According to another exemplary embodiment of the present invention, a second trust may be created whereby upon occurrence of a TMP triggering event, at least a portion of the trust certificates are transferred to the second trust and the REMIC certificates are issued from the second trust.

According to an exemplary implementation, a TMP triggering event addressed by a method according to an exemplary embodiment of the present invention occurs when an entity, which qualified as a REIT when the initial deal was affected, can no longer take advantage of the REIT exemption under the TMP regulations but does not have to transfer the equity and trust is not subject to corporate level taxation.

According to another exemplary implementation, a TMP triggering event addressed by a method according to an exemplary embodiment of the present invention occurs when the entire equity is transferred to a non-REIT entity, or to another non-qualifying entity.

According to yet an exemplary implementation a TMP triggering event addressed by a method according to an exemplary embodiment of the present invention occurs when equity is split so that at least a portion of the equity is transferred to a non-REIT, or to another non-qualifying entity.

According to exemplary embodiments of the present invention, upon occurrence of any TMP triggering event, a REMIC election takes place automatically, the trust is not taxed as a TMP, residual market value does not decrease, and investors do not have cash flow diverted to pay corporate level tax.

### BRIEF DESCRIPTION OF THE DRAWINGS

The above and other objects, features and advantages of the present invention will become more apparent from the following detailed description when taken in conjunction with the accompanying drawings in which:

FIG. 1: is a flowchart illustrating procedural steps in accordance with the general concepts of exemplary embodiments of the present invention.

FIGS. 2A-2I: provide an illustration of a document according to an exemplary implementation of an embodiment of the present invention where the terms and conditions which apply subsequent to a TMP triggering event are set forth upfront.

FIG. 3: provides an illustration of a document according to an exemplary implementation of an embodiment of the present invention setting forth REMIC termination requirements upfront.

FIGS. 4A-4G: provide an illustration of a document according to an exemplary implementation of an embodiment of the present invention where respective duties of the parties are set forth upfront.

FIG. 5: provides an illustration of a document according to an exemplary implementation of another embodiment of the present invention setting forth upfront the procedure in the case of a TMP triggering event.

FIGS. 6A-6K: provide an illustration of a document according to an exemplary implementation of another embodiment of the present invention where respective duties of the parties are set forth upfront.

FIG. 7: is a diagrammatic summary representation of transaction parties according to an exemplary embodiment of the present invention.

FIG. 8: is a flowchart illustrating an example of a conventional owner trust transaction utilizing a REIT.

FIG. 9: is a flowchart illustrating an example of a conventional REMIC structure.

In the illustrations of documents, as will be apparent to skilled artisans, the dollar amounts, percentages, dates, time periods, names of entities, and all other items which have been omitted are to be added pursuant to the specific terms as deemed appropriate by the participating parties.

### DETAILED DESCRIPTION OF EXEMPLARY EMBODIMENTS

The matters defined in the description such as specific forms, method steps and entities are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions, method steps and forms are omitted for clarity and conciseness. In this regard, it is noted that the additional details of the exemplary embodiments described below are set forth in (1) INDENTURE dated Nov. 30, 2005, CWABS TRUST 2005-HYB9 Issuer and THE BANK OF NEW YORK Indenture Trustee; (2) PROSPECTUS dated Nov. 16, 2005 and PROSPECTUS SUPPLEMENT dated Nov. 29, 2005, CWABS, INC. Depositor, Countrywide Home Loan Servicing LP Master Server and CWABS TRUST 2005-HYB9 Issuer; (3) INDENTURE dated Mar. 22, 2006, GSC Capital Corp. Mortgage Trust 2006-1 Issuing Entity and THE BANK OF NEW YORK Indenture Trustee; (4) PROSPECTUS dated Feb. 23, 2006 and PROSPECTUS SUPPLEMENT dated Mar. 20, 2006, CWABS, INC. Depositor, GSC Capital Corp. QRS Delaware Holdings, Inc. Seller, Countrywide Home Loan Servicing LP Master Server and GSC Capital Corp. Mortgage Trust 2006-1 Issuing Entity; the entire contents of all of which are hereby incorporated by reference.

Definition of Certain Terms

The following are definitions of the terms as used in the context of the present disclosure and as would be understood by skilled artisans. These definitions are non-limiting and are provided for illustrative purposes to facilitate understanding of certain exemplary implementations of the embodiments of the present invention. In this regard, terms within the definitions which are capitalized refer to terms of art as understood by skilled artisans, and are likewise not limiting but are merely explanatory.

Accepted Master Servicing Practices: With respect to any mortgage loan, those customary mortgage servicing practices of prudent mortgage servicing institutions that master service mortgage loans of the same type and quality as such mortgage loan in the jurisdiction where the related mortgaged property is located, to the extent applicable to the Indenture Trustee or the master servicer.

Certificate of Trust: The Certificate of Trust filed for the Trust pursuant to Section 3810(a) of the Statutory Trust Statute.

Certificateholder or Holder: The Person in whose name a Certificate is registered in the Certificate Register. Owners of Certificates that have been pledged in good faith may be regarded as Holders if the pledgee establishes to the satisfaction of the Indenture Trustee or the Owner Trustee, as the case may be, the pledgee's right to so act with respect to such Certificates and that the pledgee is not the Issuing Entity, any other obligor upon the Certificates or any Affiliate of any of the foregoing Persons.

Code: The Internal Revenue Code of 1986, as amended.

Eligible Account: Any of (i) an account or accounts maintained with a federal or state chartered depository institution or trust company, the long-term unsecured debt obligations and short-term unsecured debt obligations of which (or, in the case of a depository institution or trust company that is the principal subsidiary of a holding company, the debt obligations of such holding company) are rated by each Rating Agency in one of its two highest long-term and its highest short-term rating respectively, at the time any amounts are held on deposit therein, or (ii) an account or accounts in a depository institution or trust company in which such accounts are insured by the FDIC (to the limits established by the FDIC) and the uninsured deposits in which accounts are otherwise secured such that, as evidenced by an Opinion of Counsel delivered to the Indenture Trustee and to each Rating Agency, the Noteholders have a claim with respect to the funds in such account or a perfected first priority security interest against any collateral (which shall be limited to Permitted Investments) securing such funds that is superior to claims of any other depositors or creditors of the depository institution or trust company in which such account is maintained, or (iii) a trust account or accounts maintained with the corporate trust department of a federal or state chartered depository institution or trust company having capital and surplus of not less than, for example $50,000,000, acting in its fiduciary capacity or (iv) any other account acceptable to the Rating Agencies. Eligible Accounts may bear interest, and may include, if otherwise qualified under this definition, accounts maintained with the Indenture Trustee.

FDIC: The Federal Deposit Insurance Corporation, or any successor thereto.

Grant: Pledge, bargain, sell, warrant, alienate, remise, release, convey, assign, transfer, create, and grant a lien upon and a security interest in and right of set-off against, deposit, set over and confirm pursuant to the Indenture. A Grant of the Collateral or of any other agreement or instrument shall include all rights, powers and options (but none of the obligations) of the granting party thereunder, including the immediate and continuing right to claim for, collect, receive and give receipt for principal and interest payments in respect of such collateral or other agreement or instrument and all other moneys payable thereunder, to give and receive notices and other communications, to make waivers or other agreements, to exercise all rights and options, to bring proceedings in the name of the granting party or otherwise, and generally to do and receive anything that the granting party is or may be entitled to do or receive thereunder or with respect thereto.

Indenture: a legal contract.

Indenture Trustee: a trustee for the benefit of the Noteholders under an Agreement, and any successor thereto. For example, a banking corporation, not in its individual capacity, but solely in its capacity as trustee for the benefit of the Noteholders, and any corporation or national banking association resulting from or surviving any consolidation or merger to which it or its successors may be a party and any successor trustee as may from time to time be serving as successor trustee hereunder.

Issuer: an entity in a securitization that issues the securities.

Liquidated Mortgage Loan: With respect to any Payment Date, a defaulted Mortgage Loan (including any REO Property) that was liquidated in the calendar month preceding the month of such Payment Date and as to which the Master Servicer has determined (in accordance with this Agreement) that it has received all amounts it expects to receive in connection with the liquidation of such Mortgage Loan, including the final disposition of an REO Property.

Liquidation Proceeds: Amounts, including Insurance Proceeds, received in connection with the partial or complete liquidation of Mortgage Loans, whether through trustee's sale, foreclosure sale or otherwise or amounts received in connection with any condemnation or partial release of a Mortgaged Property and any other proceeds received in connection with an REO Property received in connection with or prior to such Mortgage Loan becoming a Liquidated Mortgage Loan (other than the amount of such net proceeds representing any profit realized by the Master Servicer in connection with the disposition of any such properties), less the sum of related unreimbursed Advances, Servicing Fees and Servicing Advances.

Master Servicer: An entity that generally oversees one or more servicers and aggregates information from such servicers. A servicer is an entity that collects payments from receivables, distributes such collections to the investors/owners of asset, administers the asset upon obligor's failure to make schedule payments and provides reports to the investors/owners of asset.

Mortgage: The mortgage, deed of trust or other instrument creating a first lien on or first priority ownership interest, or creating a second lien on or second priority ownership interest, as applicable, in an estate in fee simple in real property securing a Mortgage Note.

Mortgage Loans: Such of the Mortgage Loans transferred and assigned to the Indenture Trustee pursuant to the provisions hereof and any Subsequent Transfer Agreement as from time to time are held as a part of the Trust Fund (including any REO Property), the mortgage loans so held being identified in the Mortgage Loan Schedule, notwithstanding foreclosure or other acquisition of title of the related Mortgaged Property. Any Mortgage Loan subject to repurchase by Seller, Sponsor, Mortgage Lender or Master Servicer as provided, shall continue to be a Mortgage Loan hereunder until the Purchase Price with respect thereto has been paid to the Trust.

Mortgage Note: The original executed note or other evidence of indebtedness evidencing the indebtedness of a Mortgagor under a Mortgage Loan.

Opinion of Counsel: A written opinion of counsel, who may be counsel for the Depositor or the Master Servicer, reasonably acceptable to each addressee of such opinion; provided that with respect to a Sale and Servicing Agreement, or the interpretation or application of the REMIC Provisions such counsel must (i) in fact be independent of the Depositor and the Master Servicer, (ii) not have any direct financial interest in the Depositor or the Master Servicer or in any affiliate of either, and (iii) not be connected with the Depositor or the Master Servicer as an officer, employee, promoter, underwriter, trustee, partner, director or person performing similar functions.

QRS: A Qualified REIT Subsidiary within the meaning of Section 856(i) of the Code.

Qualified Insurer: A mortgage guaranty insurance company duly qualified as such under the laws of the state of its principal place of business and each state having jurisdiction over such insurer in connection with the insurance policy issued by such insurer, duly authorized and licensed in such states to transact a mortgage guaranty insurance business in such states and to write the insurance provided by the insurance policy issued by it, approved as a FNMA-approved mortgage insurer and having a claims paying ability rating of at least “AA” or equivalent rating by a nationally recognized statistical rating organization. Any replacement insurer with respect to a Mortgage Loan must have at least as high a claims paying ability rating as the insurer it replaces had on the Closing Date.

REIT: A Real Estate Investment Trust within the meaning of Section 856(a) of the Code.

REMIC Conversion: The deposit by the Issuing Entity of the Mortgage Loans (but not any REO Properties) pursuant to a pooling and servicing agreement into a common law trust with respect to whose assets one or more REMIC elections shall be made, following the occurrence of a TMP Trigger Event and the other preconditions to such conversion set forth in the Indenture and the Trust Agreement. No REMIC Conversion shall occur unless (i) the Master Servicer shall have purchased all REO properties from the Trust Estate at their fair market value and (ii) the entity seeking to separately transfer or hold any Class of the Privately Offered Notes shall have made provision for payment satisfactory to the Owner Trustee, the Indenture Trustee, the Paying Agent and the Note Registrar and others for any initial or ongoing additional administrative expenses associated with the REMIC elections made in connection with a REMIC Conversion.

Real Estate Owned (REO) Property: A Mortgaged Property acquired by the Master Servicer through foreclosure or deed-in-lieu of foreclosure in connection with a defaulted Mortgage Loan.

Swap Account: The separate Eligible Account created and initially maintained by the Indenture Trustee.

TMP Trigger Event: The occurrence of any event which causes the Issuing Entity to become taxable as a corporation (also referred to as TMP triggering effect).

Underlying REMIC Certificates: Certificates evidencing an interest in the Mortgage Loans and issued pursuant to a pooling and servicing agreement in connection with a REMIC Conversion. For example, Class A certificates generally refer to a senior interest in the mortgage loans, while Class B or Class M certificates generally refer to a subordinate interest in the mortgage loans.

### Exemplary Embodiments

According to an exemplary embodiment of the present invention, an indenture is entered into between a statutory trust, as an issuer, and for example, a banking corporation, as indenture trustee.

The issuer grants to the indenture trustee at the closing date, as trustee for the benefit of the holders of the notes, all of the issuer's right, title and interest in and to whether now existing or hereafter created by (a) the mortgage loans, replacement mortgage loans, and the proceeds thereto and all rights; (b) all funds on deposit from time to time in the collection account allocable to the mortgage loans excluding any investment income from such funds; (c) all funds on deposit from time to time in the payment account and in all proceeds thereof; (d) all funds on deposit from time to time in the pre-funding account and in all proceeds thereof excluding any investment income from such funds; (e) any REO property; and (f) each required insurance policy, and any amounts payable by the insurer under any insurance policy (to the extent the mortgagee has a claim thereto).

In addition, the issuer grants to the indenture trustee at the closing date all rights under appropriate legally binding agreements including, for example: (i) the sale and servicing agreement as assigned to the issuer, with respect to the initial and subsequent mortgage loans, and the subsequent transfer agreement, with respect to the subsequent mortgage loans as assigned to the issuer, with respect to the subsequent mortgage loans; (ii) any subservicing agreements; and (iii) any title, hazard and primary insurance policies with respect to the mortgaged properties.

Further, the issuer grants to the indenture trustee at the closing date all present and future claims, demands, causes and chooses in action in respect of any or all of the foregoing and all payments on or under, and all proceeds of every kind and nature whatsoever in respect of, any or all of the foregoing and all payments on or under, and all proceeds of every kind and nature whatsoever in the conversion thereof, voluntary or involuntary, into cash or other liquid property, all cash proceeds, accounts, accounts receivable, notes, drafts, acceptances, checks, deposit accounts, rights to payment of any and every kind, and other forms of obligations and receivables, instruments and other property which at any time constitute all or part of or are included in the proceeds of any of the foregoing (collectively, the “trust estate” or the “collateral”).

The above-described grant from the Issuer to the Indenture Trustee is made in trust to secure the payment of principal of and interest on, and any other amounts owing in respect of, the notes, equally and ratably without prejudice, priority or distinction, and to secure compliance with the provisions of the Indenture.

The indenture trustee, as trustee on behalf of the holders of the notes, acknowledges the grant, accepts the trust under the Indenture in accordance with the provisions of the indenture and agrees to perform its duties as indenture trustee. According to the indenture, the indenture trustee agrees that upon a TMP trigger event, it will make all necessary elections to cause the trust estate to be classified as one or more real estate mortgage investment conduits (REMICs) on the terms and conditions set forth under, for example, REMIC elections and administration article of the indenture, which are expressly set forth as part of the Indenture.

In an exemplary implementation, as part of the indenture, covenants are set up which include, but are not limited to, the following.
The issuer covenants with the indenture trustee that it will not enter into any amendment or supplement to the sale and servicing agreement without the prior written consent of the indenture trustee. Subsequent to a TMP trigger event, the indenture trustee shall not enter into any such amendment or supplement without receiving an opinion of counsel to the effect that such amendment or supplement will not cause the imposition of any tax on the trust or the noteholders or cause the REMIC to fail to qualify as a REMIC at any time that any notes are outstanding.
For purposes of perfection under Section 9-305 of the Uniform Commercial Code or other similar applicable law, rule or regulation of the state in which such property is held by the master servicer, the issuer and the indenture trustee hereby acknowledge that the master servicer is acting as bailee of the indenture trustee in holding amounts on deposit in the collection account, as well as its bailee in holding any related document in the mortgage file released to the master servicer, and any other items constituting a part of the trust estate which from time to time come into the possession of the master servicer. It is intended that, by the master servicer's acceptance of such bailee arrangement, the indenture trustee, as a secured party of the mortgage loans, will be deemed to have possession of such document, such monies and such other items for purposes of Section 9-305 of the Uniform Commercial Code of the state in which such property is held by the master servicer. The indenture trustee shall not be liable with respect to such documents, monies or items while in possession of the master servicer.

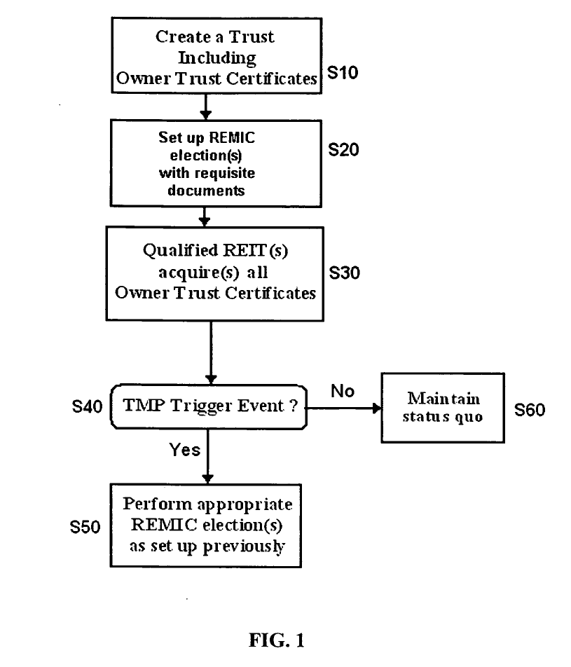

Referring to FIG. 1, embodiments of the present invention broadly provide for creation of a trust (step S10). At closing, an outline of at least one REMIC election that is to take place in case of TMP triggering event (step S20) is prepared and agreed upon by perspective security holders as a condition of purchase, and all trust certificates are acquired by one or more qualified REIT(s) and/or QRS(s). The entities which acquire trust certificates agree to maintain the status (step S60) quo with regard to remaining qualified REIT(s) and/or QRS(s) under the Code. If a TMP trigger event (as described more fully below) occurs (as determined at step S40) then appropriate REMIC election(s) are performed (step S50) as outlined upfront during the closing.

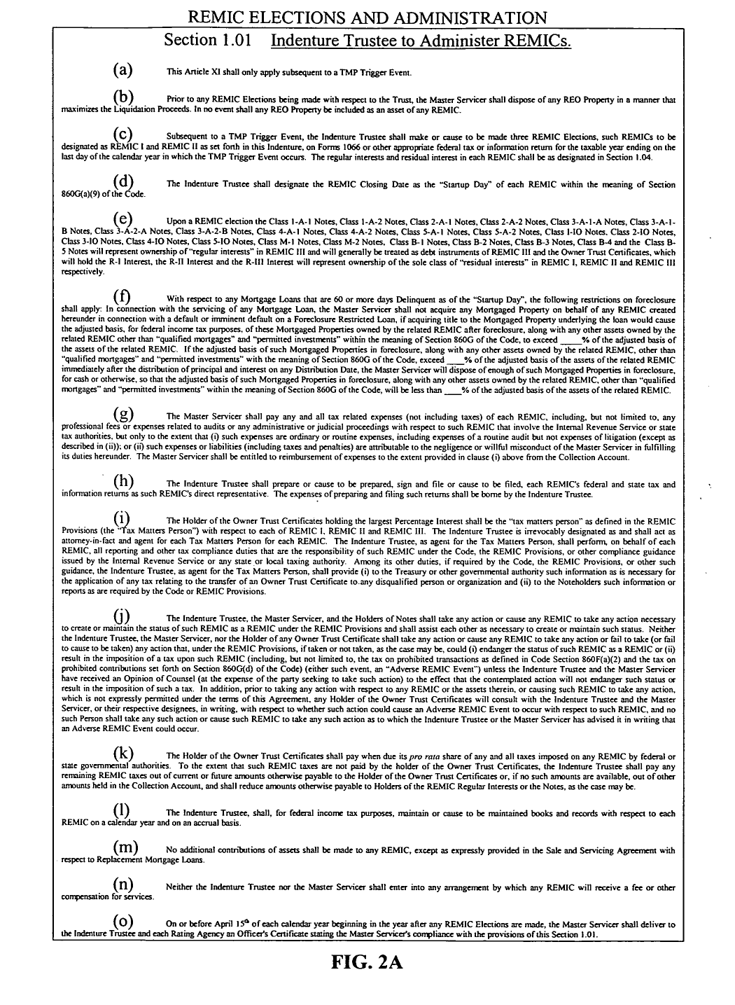

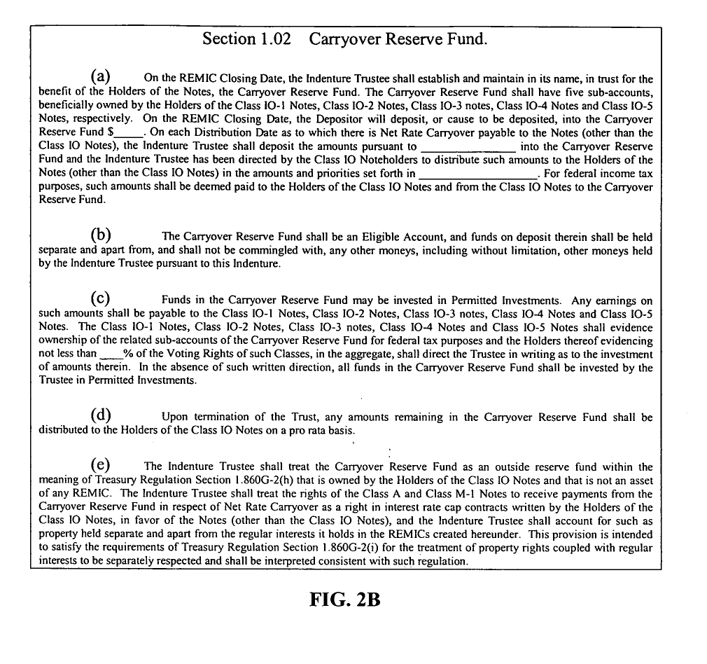

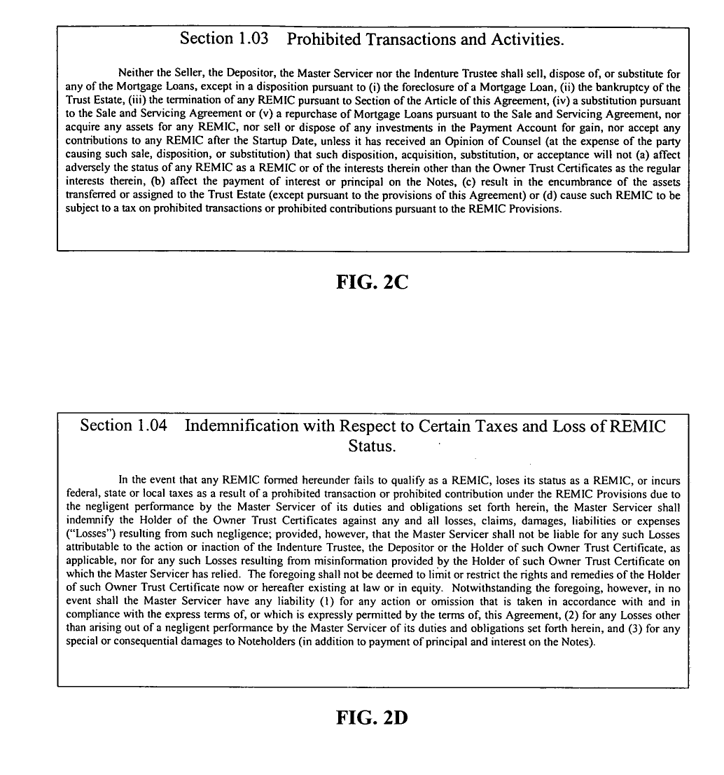

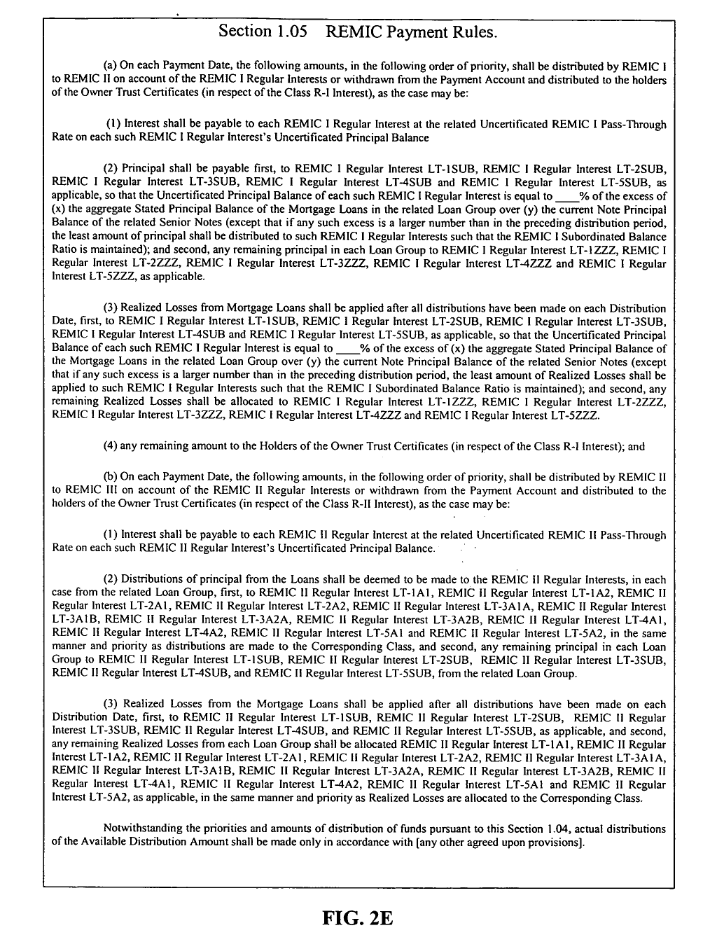

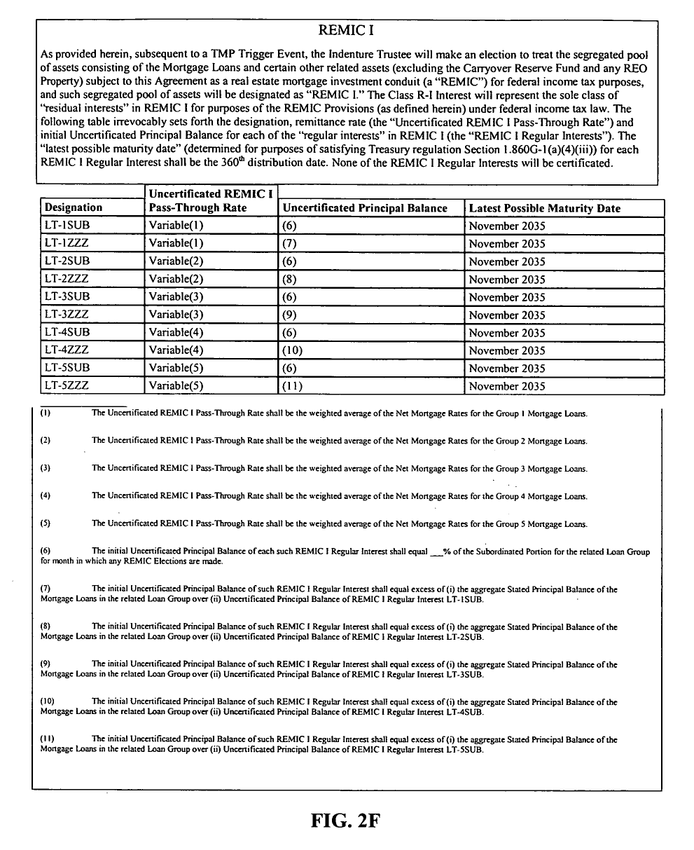

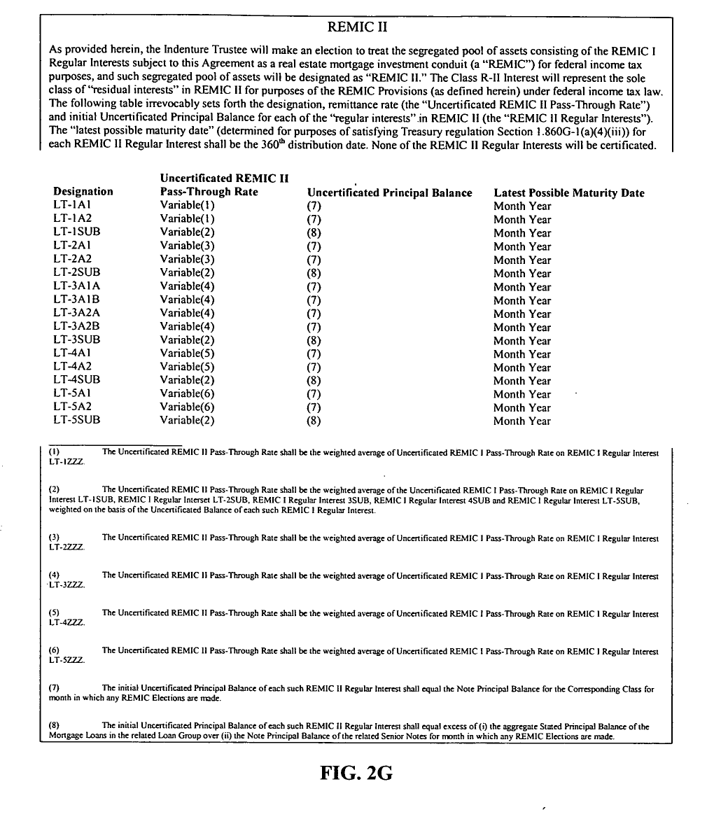

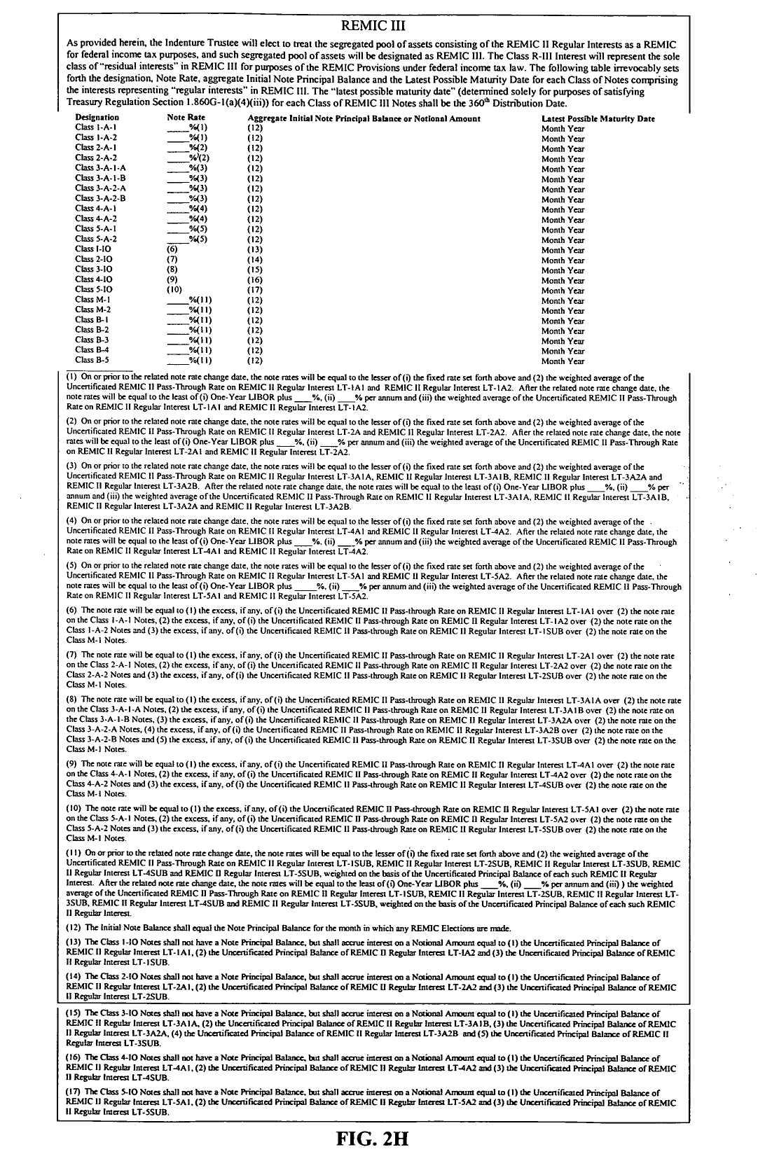

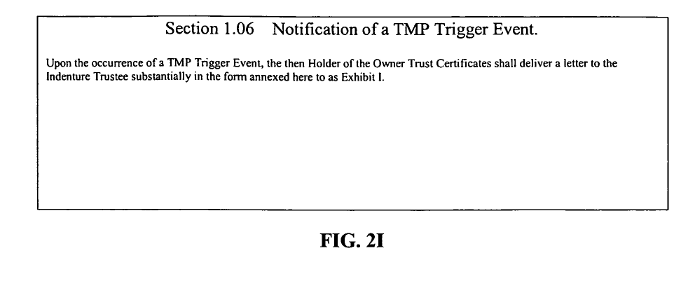

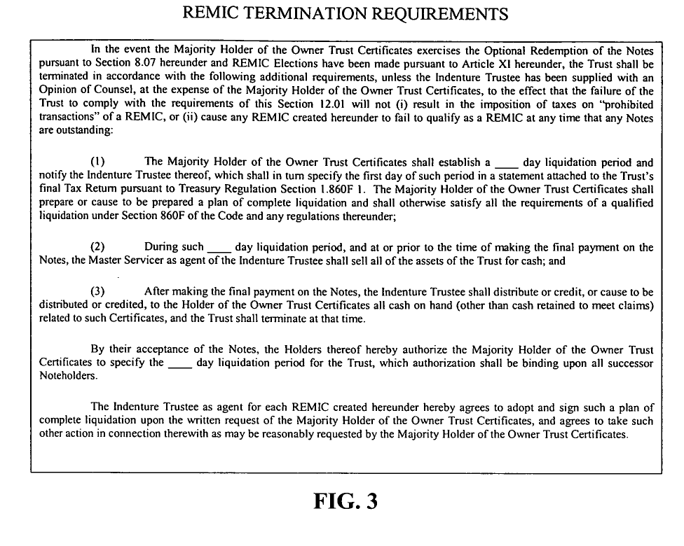

In an exemplary implementation, where the indenture trustee is to administer one or more REMIC(s), the terms and conditions which apply subsequent to a TMP triggering event may be set up under REMIC elections and administration article of the indenture as shown in FIGS. 2A-2I, and REMIC termination requirements may be set up as shown in FIG. 3. The tax consequences due to the taxation of the trust in general and after TMP triggering event are generally as follows.

In an exemplary implementation, it is anticipated that the trust will be characterized for federal income tax purposes as one or more taxable mortgage pools, or TMPs. In general, a TMP is treated as a separate corporation not includible with any other corporation in a consolidated income tax return and is subject to corporate income taxation. However, it is anticipated that on the closing date 100% of the owner trust certificates and Class IO, Class M-2 and Class B notes will be acquired by a trust, directly or indirectly through one or more qualified REIT subsidiaries (within the meaning of Section 856(i) of the Code) thereof or one or more entities disregarded as entities separate from the trust or its qualified REIT subsidiaries.

With regard to the classes of notes (such as Class A, Class IO, Class M-2 and Class B Notes) referenced throughout the specification, these classes are merely exemplary, and any classification appropriate in multi-class securities structures is contemplated with the scope of the present invention. For example, various multi-class pay structures and senior/subordinate structures known in the art (as described, for example, in the background of the invention section of this specification) may be implemented. Examples of multi-class structures according to illustrative implementations of certain exemplary embodiments of the present invention are shown in FIGS. 2H, 4C-4E and 6C-6E. In the exemplary implementation described above, Class M-2 notes and Class B notes are subject to “will be debt” opinion which means that these notes are not characterized as indebtedness for federal income tax purposes, and Class IO notes generally refer to interest only notes.

On the closing date, the trust represents that (i) it will file with its federal income tax return for its taxable year an election to be a real estate investment trust within the meaning of section 856(a) of the Code, or REIT, (ii) it has been organized in conformity with the requirements for qualification and taxation as a REIT, (iii) it currently operates and intends to continue to operate in a manner that enables it to meet the requirements for qualification and taxation as a REIT, (iv) as of the closing date it will own for federal income tax purposes, directly or indirectly through one or more qualified REIT subsidiaries or one or more entities disregarded as entities separate from the Trust or a qualified REIT subsidiary thereof, 100% of the owner trust certificates and Class IO, Class M-2 and Class B notes, and (v) it intends to maintain its status as a REIT and the status of each other entity necessary for the correctness of clause (iv) as a qualified REIT subsidiary of the trust or as an entity disregarded as an entity separate from the trust or any such qualified REIT subsidiary until the earlier of (a) the date on which none of the notes is outstanding or (b) the date on which the trust has transferred 100% of the owner trust certificates and Class IO, Class M-2 and Class B notes (other than any Class M-2 notes and Class B notes with respect to which a “will be debt” opinion has been rendered to the trust by nationally recognized tax counsel) to another entity that qualifies as a REIT or one or more qualified REIT subsidiaries of such REIT or one or more entities disregarded as entities separate from such REIT or such qualified REIT subsidiaries (in accordance with the terms of the indenture and the trust agreement).

So long as 100% of (i) the owner trust certificates, (ii) the Class IO notes and (iii) any Class M-2 notes and Class B notes are not characterized as indebtedness for federal income tax purposes (the securities referred to in the immediately preceding clauses (i), (ii) and (iii) collectively referred to herein as the “equity securities”) are owned by a single REIT, directly or indirectly through one or more qualified REIT subsidiaries of such REIT or one or more entities disregarded as entities separate from such REIT or its qualified REIT subsidiaries, classification of the trust as a TMP will not cause it to be subject to corporate income taxation.

Rather, the consequence of the classification of the trust as a TMP is that the shareholders of the REIT will be required to treat a portion of the dividends they receive from the REIT as though they were “excess inclusions” with respect to a residual interest in a REMIC within the meaning of Section 860D of the Code. In the event that 100% of the equity securities are no longer owned by a single REIT, directly or indirectly through one or more qualified REIT subsidiaries of such REIT or one or more entities disregarded as entities separate from such REIT or its qualified REIT subsidiaries, the trust would become subject to federal income taxation as a corporation and would not be permitted to file a consolidated federal income tax return with any other corporation.

Pursuant to the trust agreement and the indenture, no transfer of the owner trust certificates or Class IO, Class M-2 and Class B notes (other than any Class M-2 notes and Class B notes with respect to which a “will be debt” opinion has been rendered to the trust by nationally recognized tax counsel) will be permitted, except that (i) 100% of such owner trust certificates and Class IO, Class M-2 and Class B notes may be transferred in a single transaction to another entity that qualifies as a REIT, directly or by transfer to one or more qualified REIT subsidiaries of such REIT or one or more entities disregarded as entities separate from such REIT or its qualified REIT subsidiaries, and (ii) such owner trust certificates and Class IO, Class M-2 and Class B notes may be pledged to secure indebtedness or be the subject of repurchase agreements treated by the parties thereto as secured indebtedness for federal income tax purposes, and such owner trust certificates and Class IO, Class M-2 and Class B notes may be transferred under any such related loan agreement or repurchase agreement upon a default under any such indebtedness. To avoid doubt, any Class M-2 notes and Class B notes with respect to which a “will be debt” opinion has been rendered to the trust by nationally recognized tax counsel will not be subject to the foregoing transfer restrictions.

A TMP triggering event occurs when, for example, the equity securities are transferred to an entity that does not qualify either as a REIT or as a QRS or the indenture trustee obtains a certification that the entity which owns the Equity Securities is no longer a REIT or a QRS. At that time, subject to certain provisions, one or more REMIC elections will be made with respect to the Issuer. If a TMP triggering event occurs, the master servicer is required to sell from the trust any REO property at the fair market value, and either restrict foreclosure or sell from the trust any 60 day or more delinquent loan. After a TMP triggering event and the related REMIC elections, investment in the offered notes will constitute indebtedness for federal income tax purposes and the trust would not be subject to federal income taxation as a corporation. As a condition of purchase, the holders of the notes are deemed to have consented to any such REMIC election upon occurrence of a TMP triggering event.

Upon the occurrence of a TMP triggering event, the trust will be subject to federal income taxation, as described above, only for the period of time between such TMP trigger event and the date the related REMIC elections become effective.

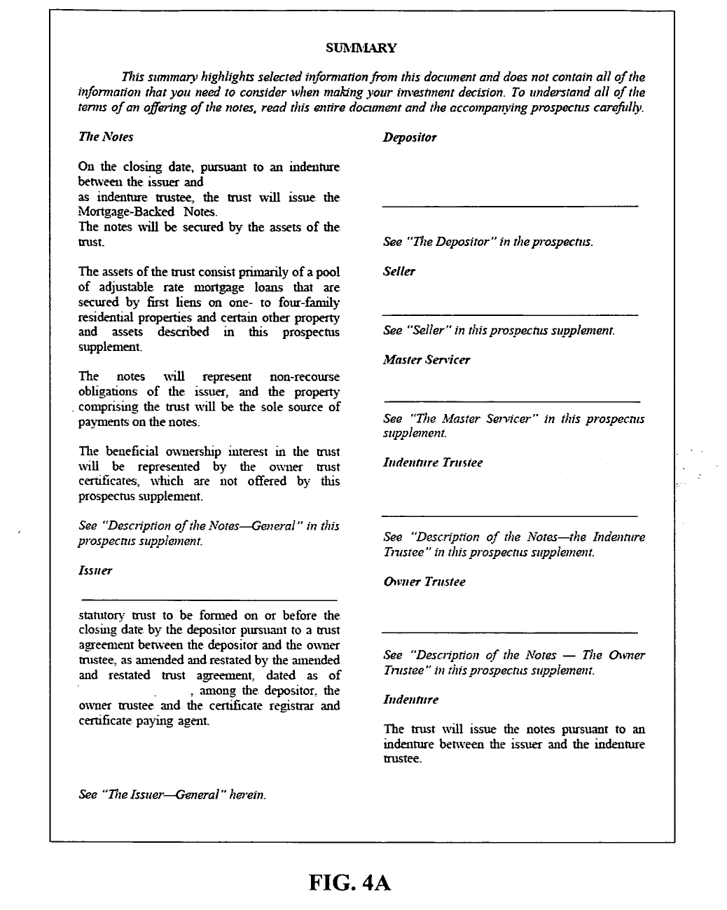

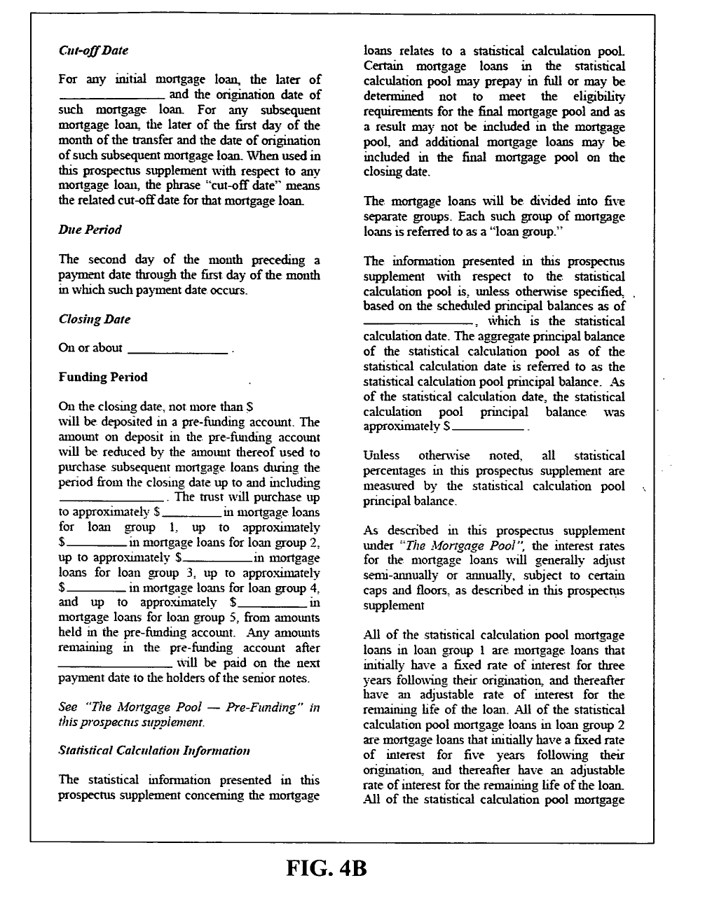

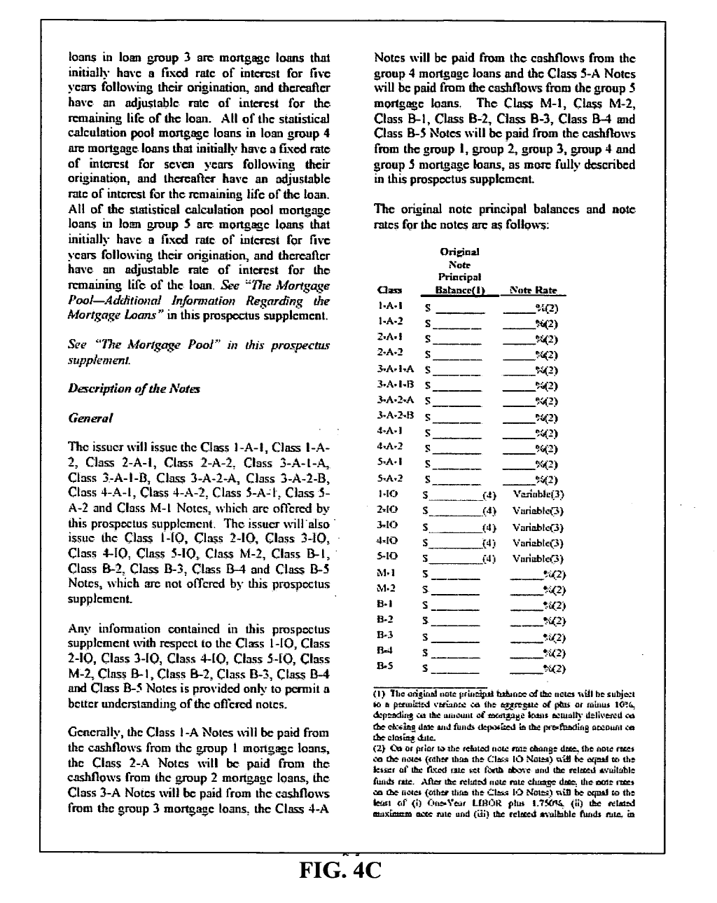

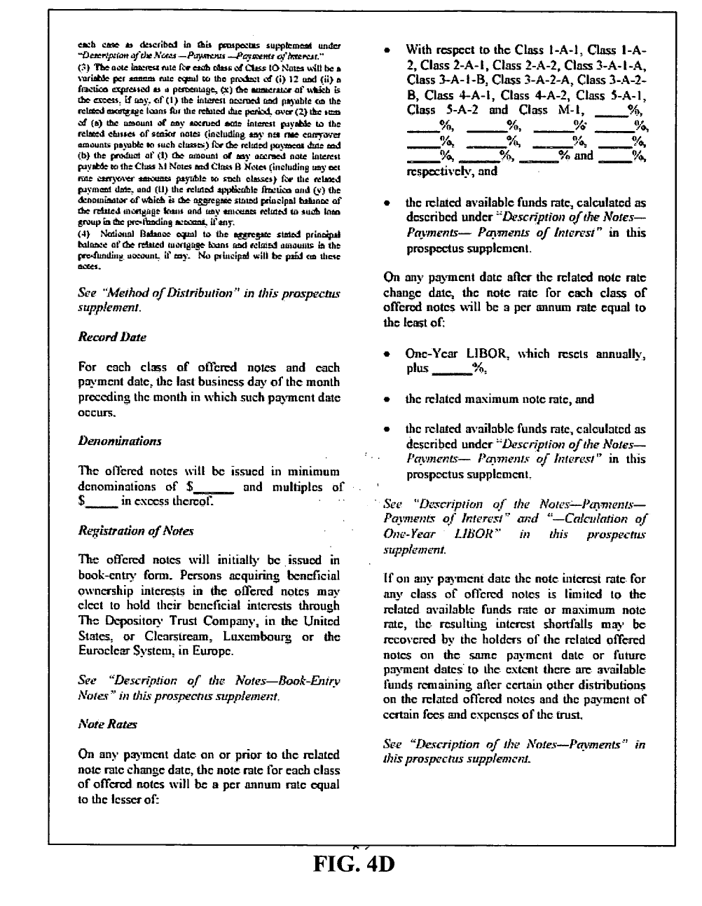

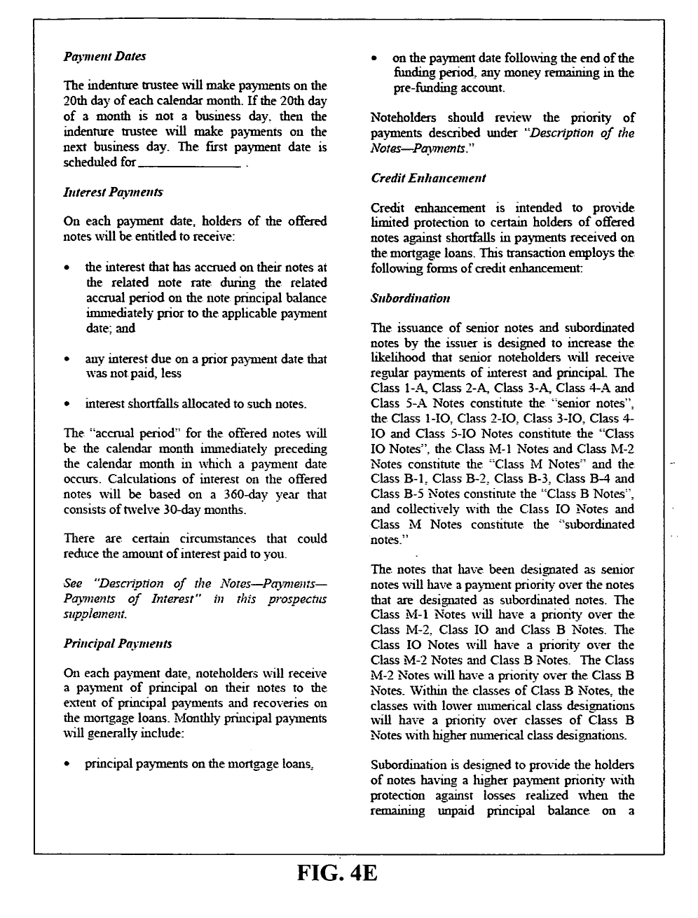

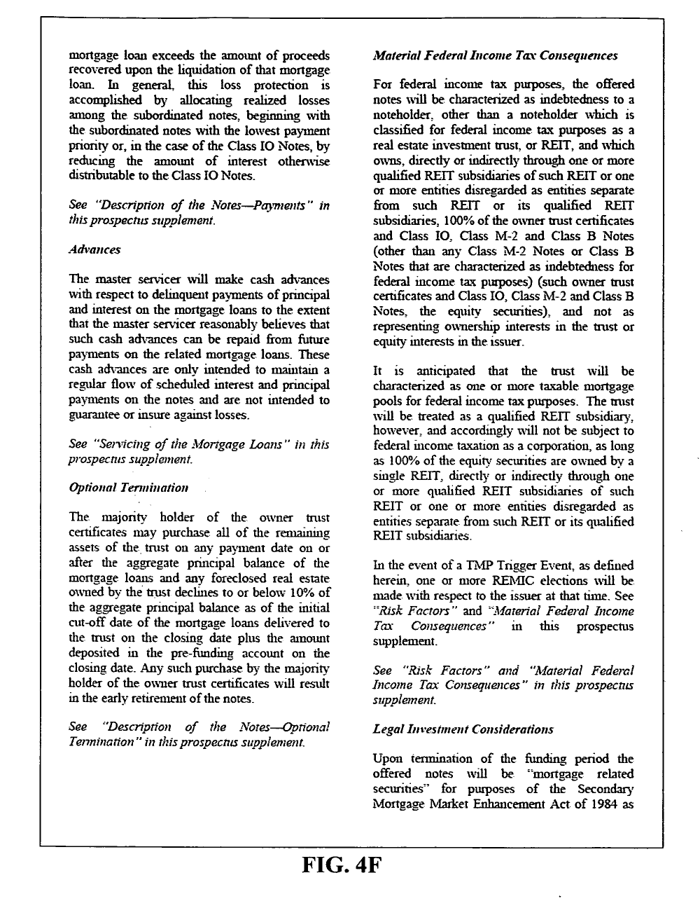

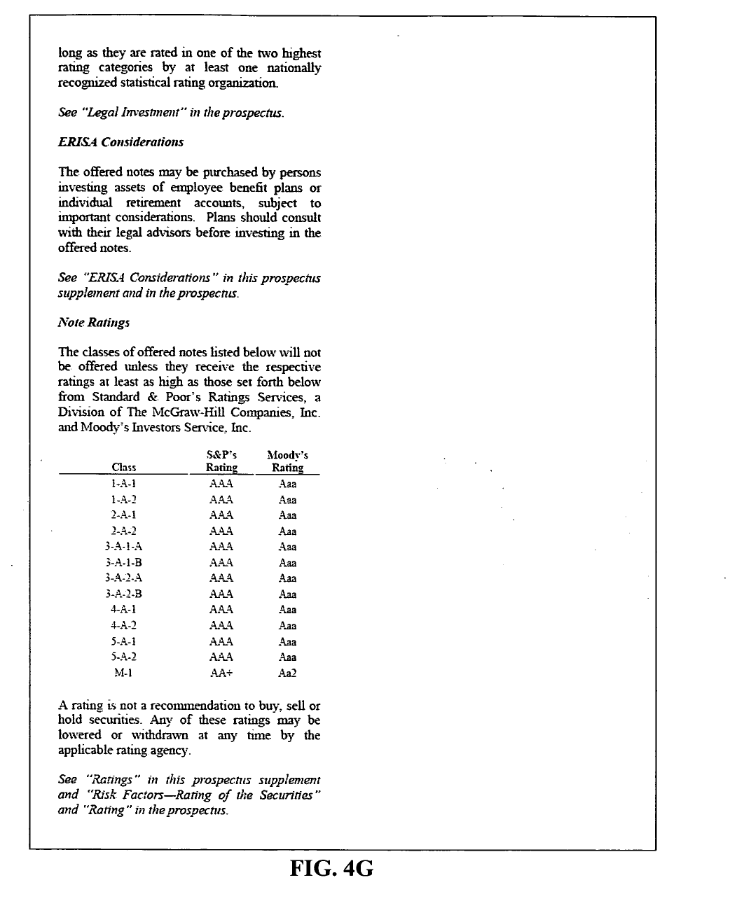

FIGS. 4A-4G set forth an example of a Summary of a Supplement to a Prospectus outlining the respective duties of the parties in accordance with an exemplary implementation of an embodiment of the present invention.

According to an exemplary embodiment of the present invention, once the lender takes possession of the equity—forecloses on the equity—the lender notifies the trustee. The trustee notifies the master servicer, and the master servicer is required to buy out all the REO property at fair market value, because the REO properties are not suitable REMIC assets. That is, the master servicer sells out all the REO properties, notifies the trustees of the proceeds, the trustee then takes those REO proceeds and pays down the bonds: writes down the subordinate bonds and pays down the senior bonds. The trustee then, within the context of the existing owner trust makes a REMIC election. The owner trust notes are exchanged for REMIC notes which are issued by the same owner trust, in this exemplary embodiment.

As noted above, there is a small window of time (typically only for a couple of days) when some corporate level tax liability exists with respect to the TMP, because the lender takes possession of the equity in terms of foreclosure.

According to the above-described exemplary implementation, a REMIC election is made by issuing REMIC certificates out of the same, preexisting trust.

Another exemplary implementation of the present invention is described as follows.

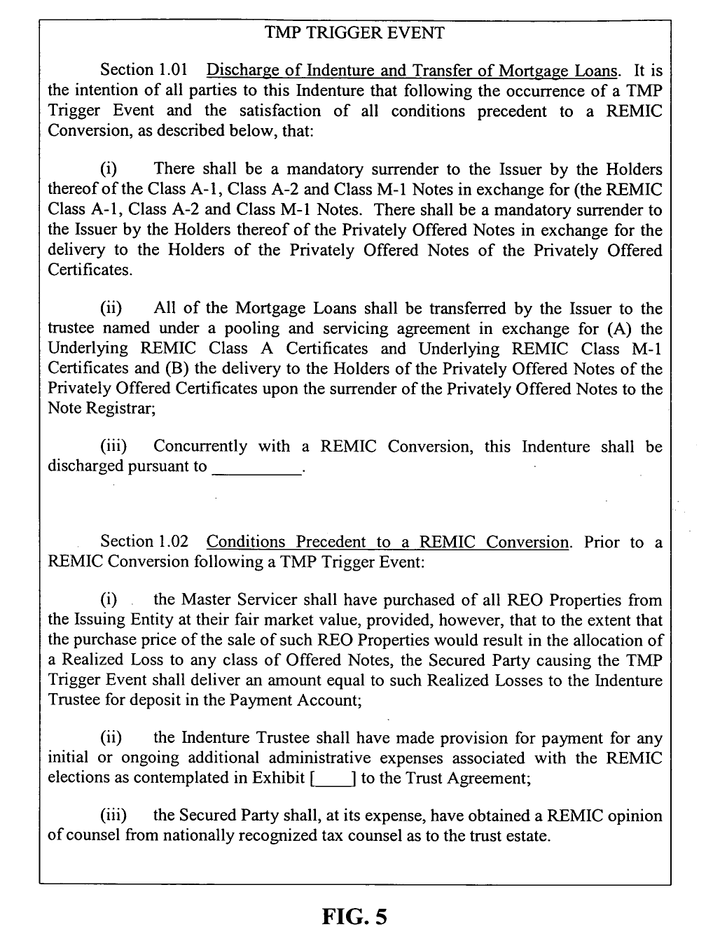

An owner trust (Trust A) issues original notes and the owner trust equity, or the owner trust certificates, which is the equity. Upon a TMP trigger event (as set up upfront in an article of an indenture, as shown in FIG. 5), the lender notifies the trustee, the trustee sells all non REO loans. Essentially, the REO loans get bought out, so that the master servicer sells all the REO loans and these proceeds are transferred back through the normal waterfall of the original owner trust. All the other loans get transferred from trust A to a trust B, where the REMIC election is made in trust B. Trust B issues new REMIC certificates tranched in the same manner as trust A, for example time tranched.

From that point, the new REMIC certificates are transferred out of trust B and are bifurcated. The new REMIC certificates from trust B that correspond to the publicly offered classes of trust A are transferred back into trust A, deposited in trust A, and they will serve as collateral for the newly issued notes which will be described below. The new REMIC certificates from trust B that correspond to the nonpublic bonds from trust A, including the equity, are transferred straight back to the entity that was holding the original certificates.

As noted above, the new REMIC certificates that correspond to the publicly owned classes go from trust B to trust A. They serve as collateral for the owner trust issuing new REMIC notes backed by the new REMIC certificates from trust B. Trust A issues new REMIC notes collateralized by the new REMIC certificates issued by trust B and deposited to trust A. Then, trust A note holders exchange the original notes for the newly issued REMIC notes.

Accordingly, from a tax perspective, the debt is retired and new notes are reissued. On the other hand, from the SEC perspective, it is simply an exchange of notes. This is a taxable exchange for bond holders. Also, all of the various issuances of the securities, at least those that are public, are registered. That is, they are initially registered in the owners trust. Then, they are registered when they come out of trust B as REMIC certificates. The trust A issuance of the new REMIC notes is also registered.

According to this exemplary embodiment of the invention, the REMIC election is made by issuing REMIC certificates from a new trust. That is, a REMIC election is made that utilizes a new trust, so as to ensure that a proper REMIC election takes place that will not inadvertently result in creating a TMP.

In accordance with an exemplary implementation, while a new trust issued the REMIC certificates, the same owner trust can issue the notes that go back to the bond holders, the underlying collateral of which are the REMIC certificates.

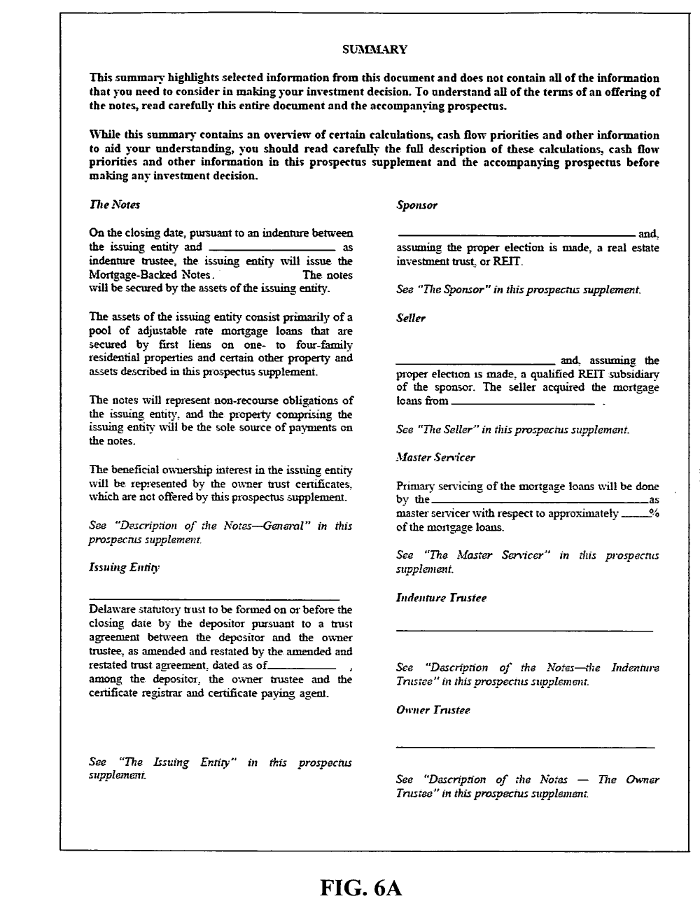

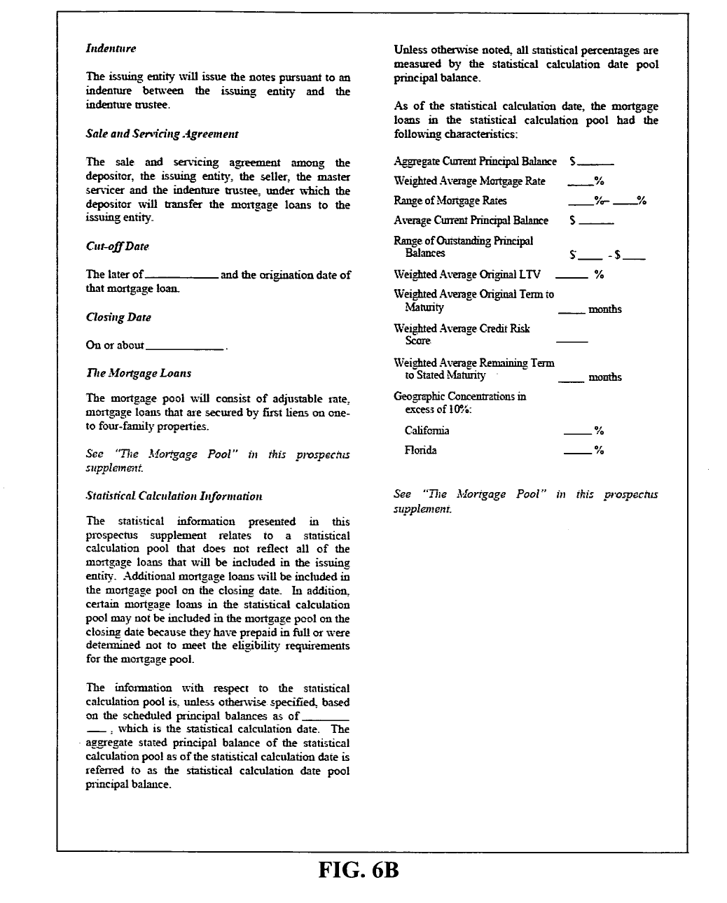

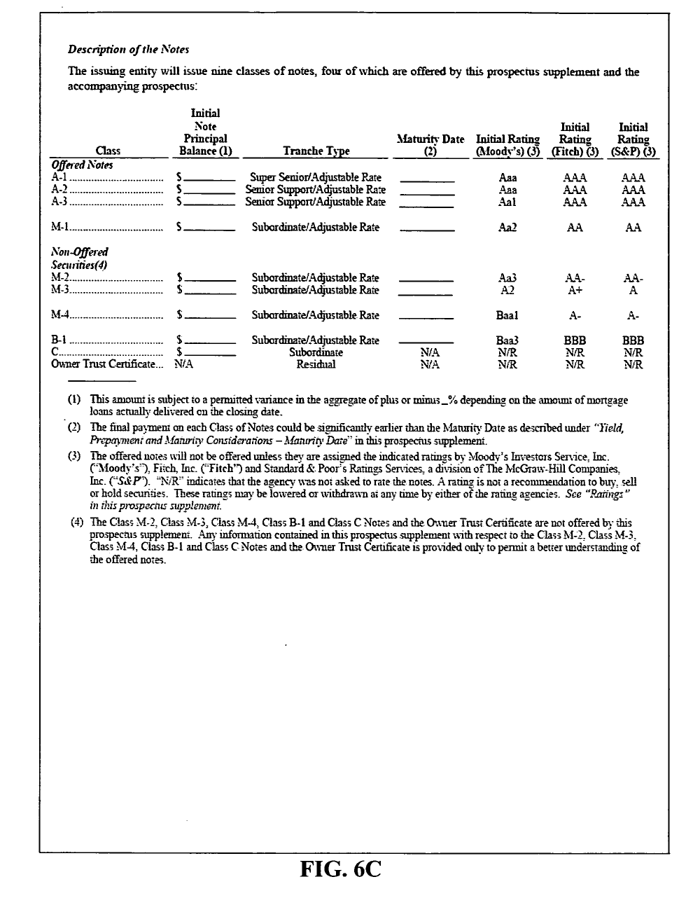

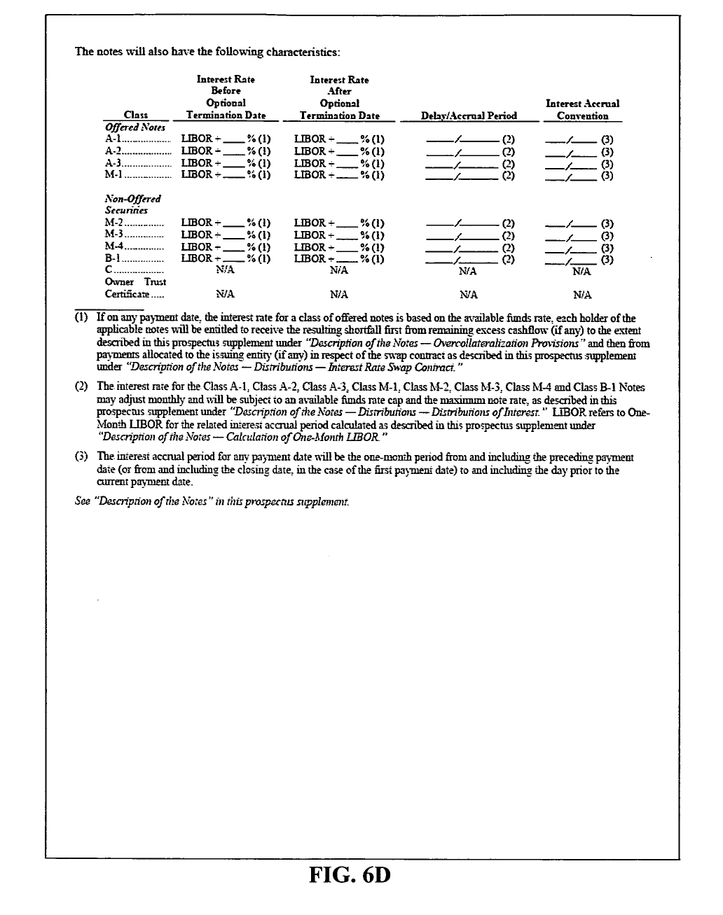

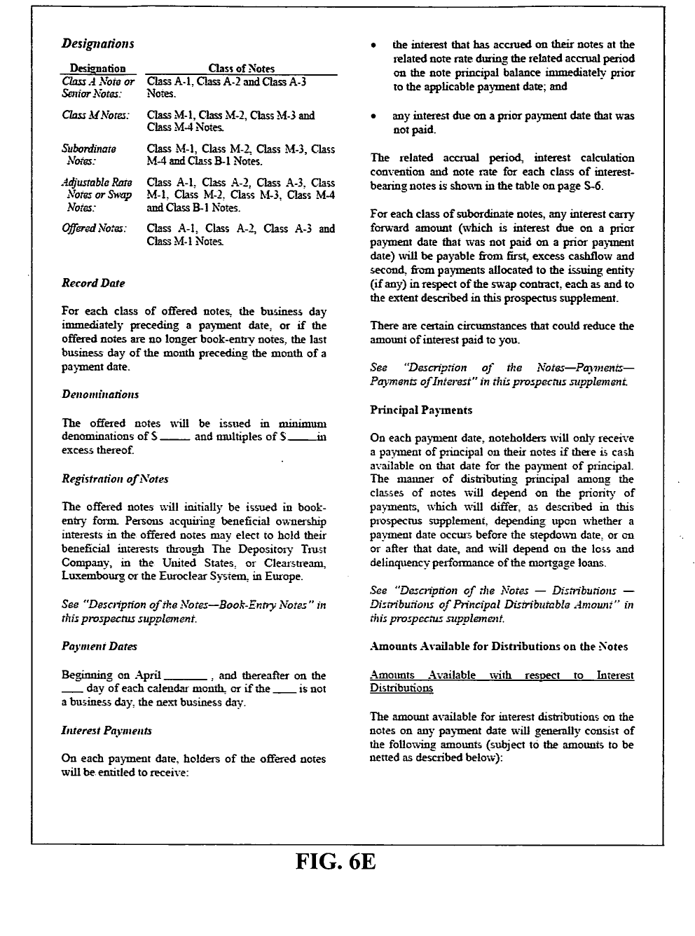

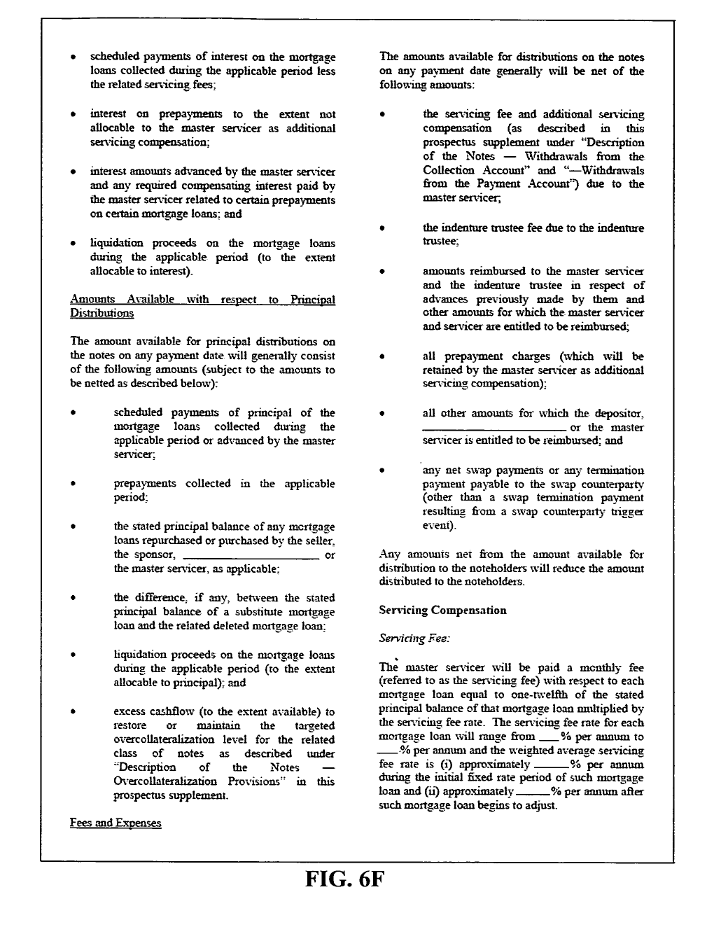

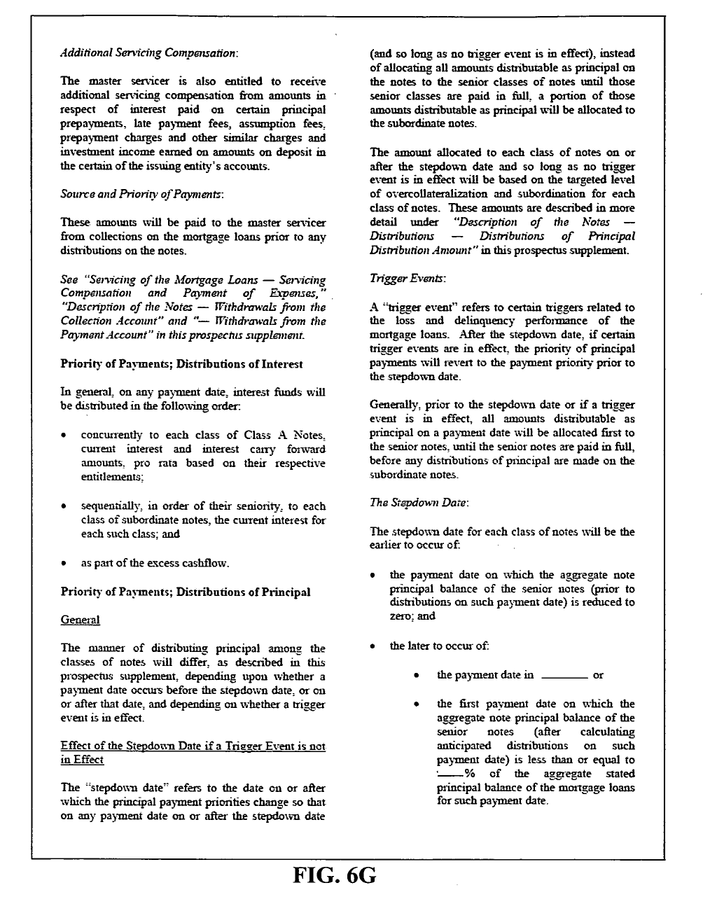

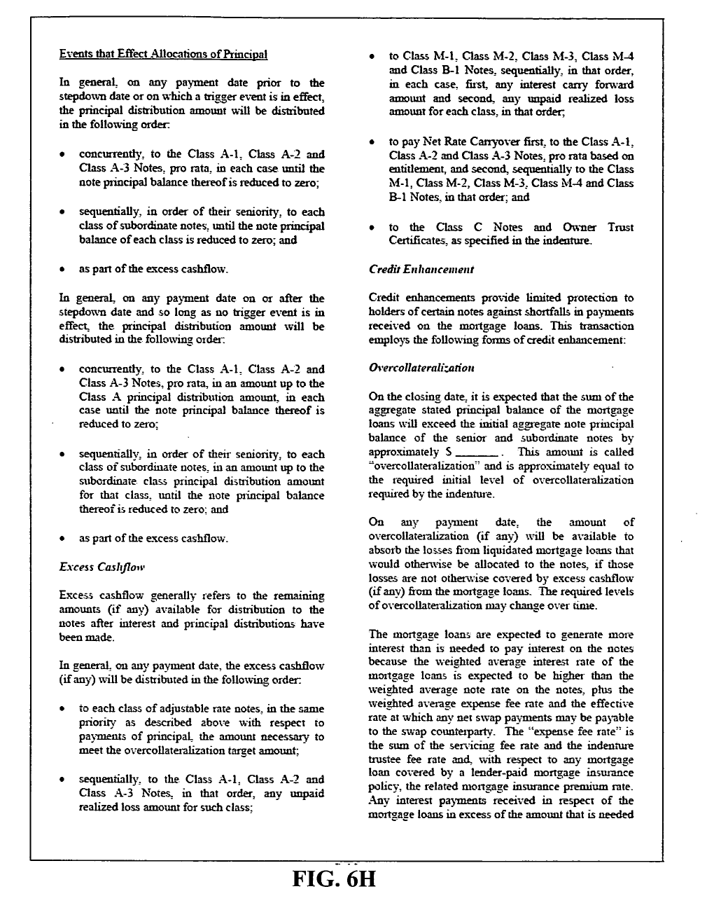

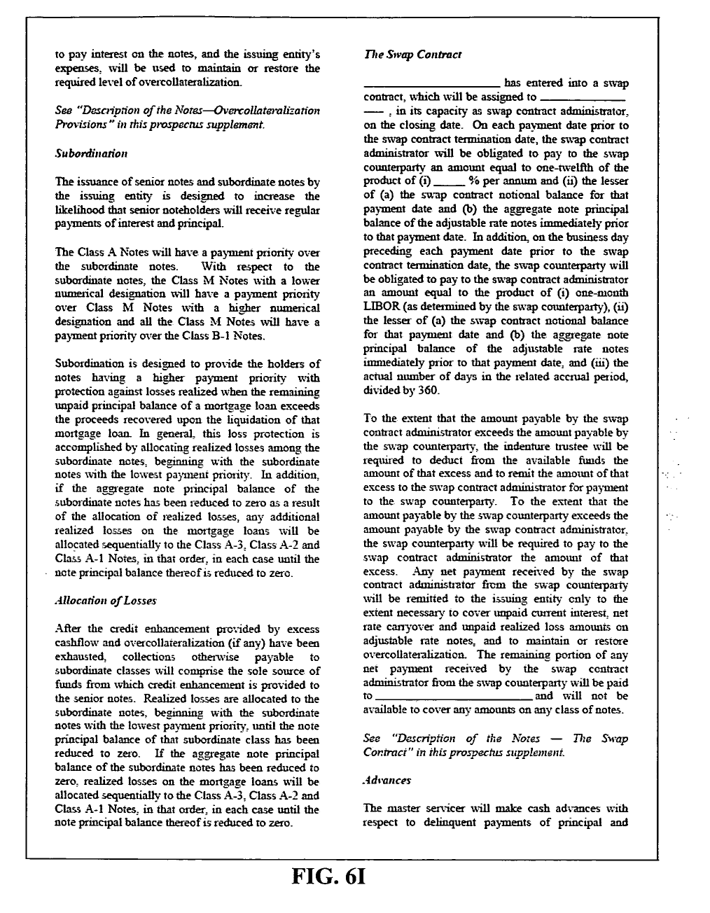

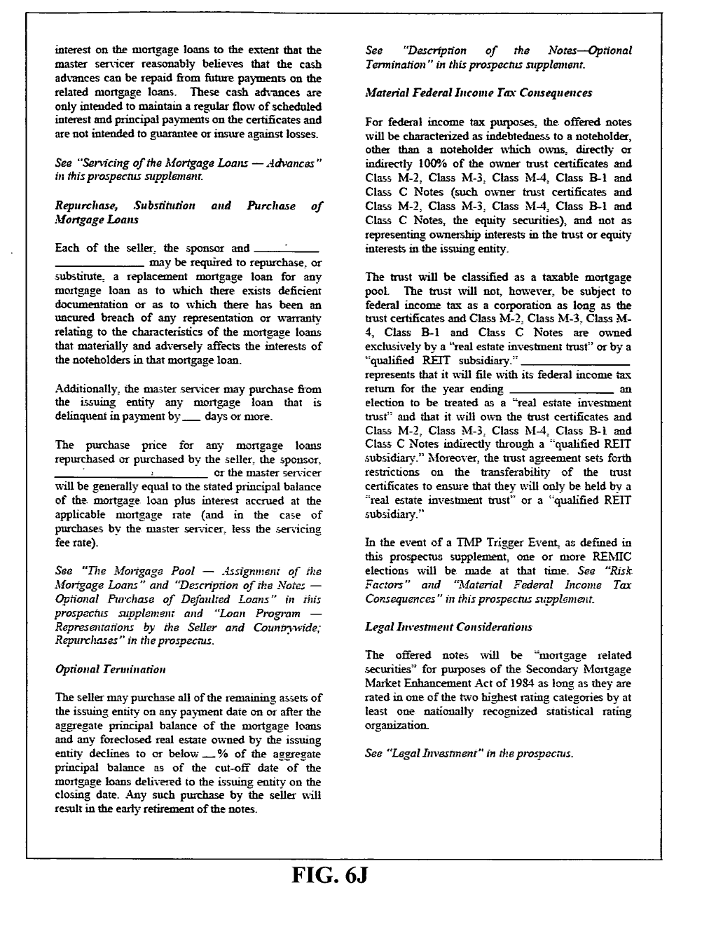

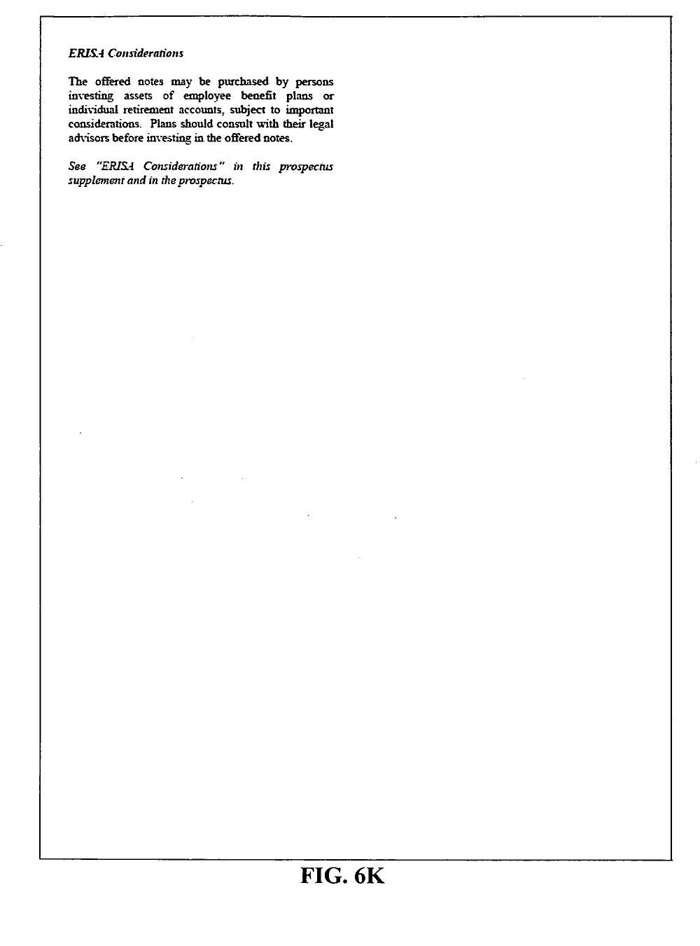

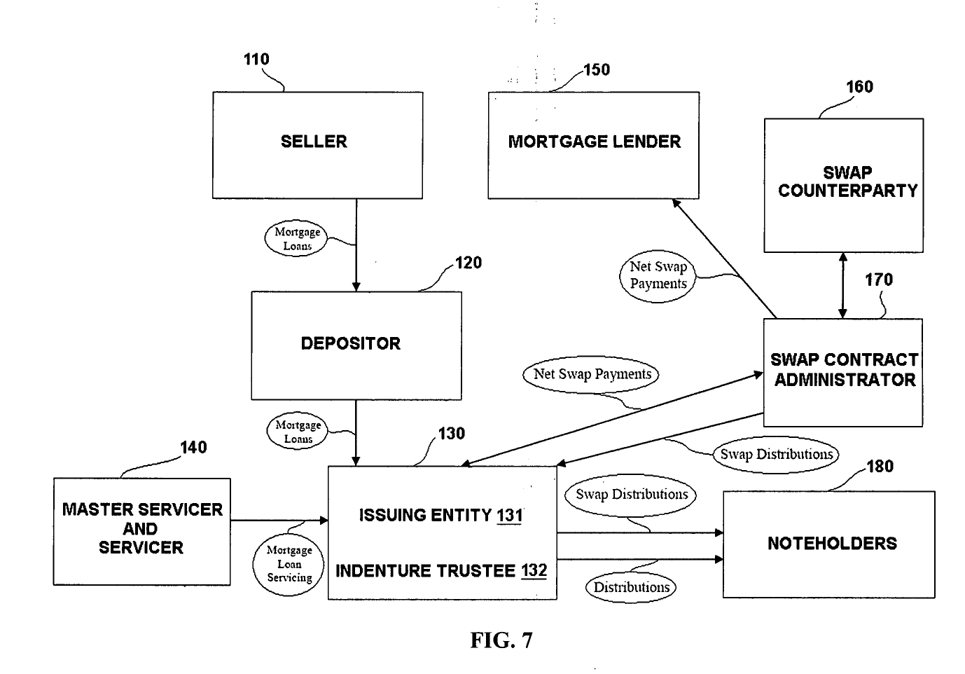

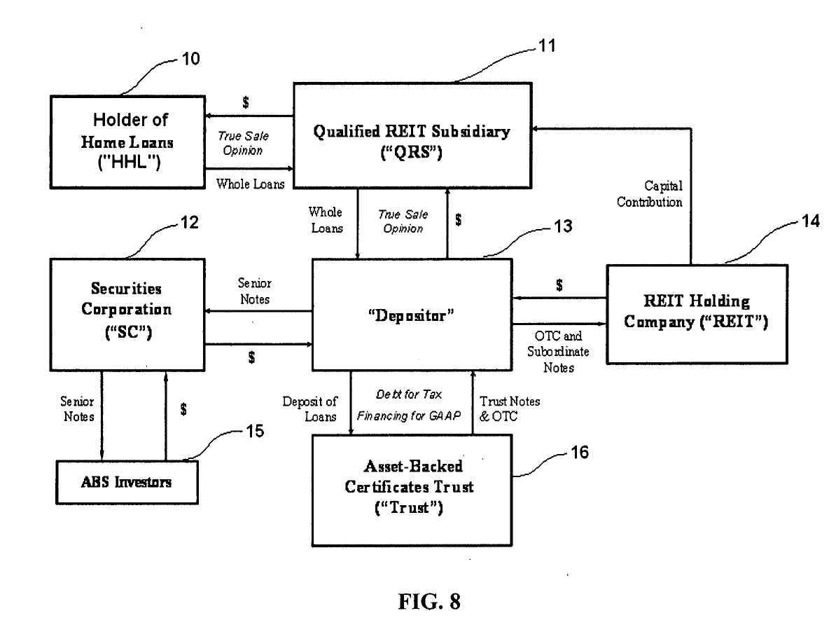

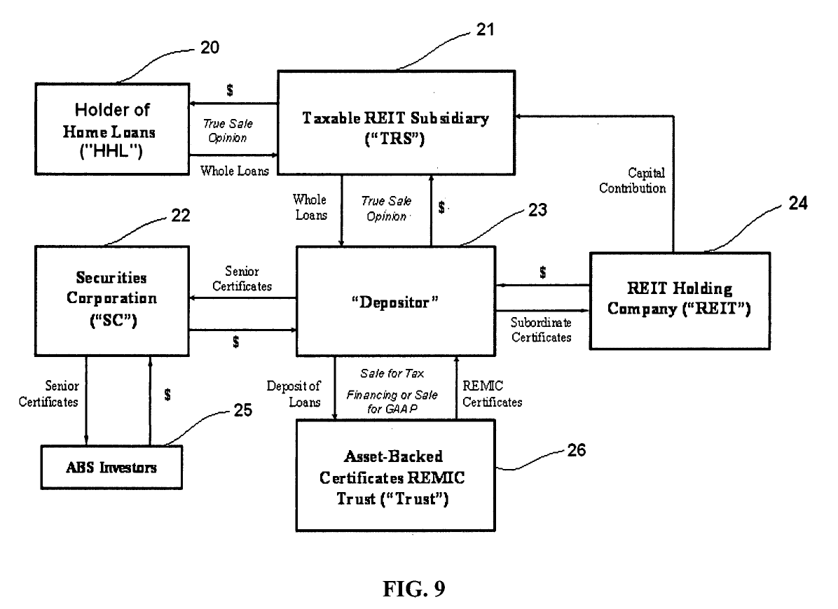

FIGS. 6A-6K illustrate an example of a structured finance document outlining the respective duties of the parties in accordance with an exemplary implementation of an embodiment of the present invention. On the other hand, FIG. 7 is a diagrammatic summary representation of transaction parties. In this diagram, the mortgage loans are transferred from seller 110 to depositor 120 and then to issuing entity 131 and indenture trustee 132 (collectively shown as entity 130). The net swap payments take place between entity 130 and swap contract administrators 170. Swap distributions are made from swap contract administrator 170 to entity 130, and from entity 130 to noteholders 180. Distributions are also made from entity 130 to noteholders 180. Swap contract administrators 170 interact with swap counterparty 160, and net swap payments are made from swap contractors 170 to mortgage lender 150.

Taxation of the issuing entity after a TMP trigger event according to the above-describe exemplary embodiments is described as follows.

To avoid the adverse tax consequences of any recharacterization of the issuing entity as a taxable mortgage pool, the trust agreement and the indenture provide that if the issuing entity becomes a taxable mortgage pool that is subject to federal income tax as a corporation (a “TMP trigger event”), subject to certain provisions, the master servicer, on behalf of the indenture trustee, will undertake certain steps, including the following: the master servicer will purchase from the issuing entity any REO property at its fair market value (to the extent that the purchase price of the sale of such REO properties would result in the allocation of a realized loss to any class of offered notes, the party causing the TMP trigger event shall contribute an amount equal to such realized losses), and will either restrict foreclosure on (within the Underlying REMIC Trust, as described below) or sell from the issuing entity any mortgage loan that is then 60 or more days delinquent; the indenture trustee will cause certain of the remaining assets of the issuing entity to be transferred to a new entity (the “underlying REMIC trust”), with respect to which one or more REMIC elections will be made, in exchange for certain REMIC certificates to be issued by the underlying REMIC trust; the issuing entity will make a REMIC election with respect to those REMIC certificates (the “trust REMIC”) and issue new notes secured by those REMIC certificates (which new notes would represent ownership of REMIC regular interests in the trust REMIC); and the new notes will be transferred to beneficial owners of offered notes in exchange for their offered notes.

Solely for federal income tax purposes, each new note issued by the issuing entity would, for federal income tax purposes, comprise two components: a REMIC regular interest in the trust REMIC and a separate contractual right to (i) receive payments in respect of net rate carryover and (ii) the obligation to make payments to the swap account. The economic attributes and entitlements of each such REMIC regular interest and related contractual right would, in the aggregate, be substantially identical to those of the offered note for which they would be exchanged. Nevertheless, the beneficial owner of each offered note would recognize gain or loss on the exchange in an amount equal to the difference, if any, between such beneficial owner's adjusted basis in the offered note and sum of the fair market value of the REMIC regular interest, which in certain circumstances may be deemed to be equal to its then current principal balance, and the fair market value of the related contractual right received in exchange therefor.

Although several exemplary embodiments of the present invention have been disclosed for illustrative purposes, those skilled in the art will appreciate that various modifications, additions and substitutions are possible, without departing from the scope of the invention. Accordingly, the present invention is not limited to the above-described embodiments, and it will be understood by those skilled in the art that various changes in form and detail may be made therein without departing from the spirit and scope of the invention as defined by the appended claims and equivalents.

I claim:

1. A method for financing equity, the method comprising:
creating a trust classifiable as a taxable mortgage pool (TMP);
acquiring at closing approximately 100% of the trust certificates by at least one entity qualifying as a real estate investment trust (REIT), or as a qualified REIT subsidiary (QRS), within the meaning of Section 856(i) of the Internal Revenue Code of 1986 (Code);
defining at the closing at least one real estate mortgage investment conduit (REMIC) election;
upon occurrence of a TMP triggering event, which causes an issuing entity to become taxable as a corporation within the meaning of the Code, converting the trust certificates to REMIC certificates pursuant to the at least one REMIC election defined at the closing.

2. The method as claimed in claim 1, wherein the converting of the trust certificates to the REMIC certificates comprises:
taking possession by a lender of an equity held by the issuing entity and notifying the trust;
notifying a master servicer of the taking of the possession by the lender;
buying out by the master service of Real Estate Owned (REO) property;
notifying the trust of the buying out; and
making the at least one REMIC election within the trust.

3. The method as claimed in claim 1, wherein the TMP triggering event comprises at least one of:
the at least one entity failing to qualify as a REIT after the closing;
an entire equity being transferred to a non-REIT entity, or to another non-qualifying entity; and
the equity being split so that at least a portion of the equity is transferred to a non-REIT entity, or to another non-qualifying entity.

4. The method as claimed in claim 1, further comprising issuing the REMIC certificates from the trust.

5. The method as claimed in claim 1, further comprising:
upon the occurrence of the TMP triggering event, transferring at least a portion of the owner trust certificates to a new trust, wherein the at least one REMIC election is made in the new trust; and
issuing the REMIC certificates from the new trust.

6. The method as claimed in claim 1, further comprising making a plurality of REMICs elections.

7. The method as claimed in claim 4, wherein the REMIC certificates represent ownership of at least one of regular interests and residual interests.

8. The method as claimed in claim 6, wherein each of the plurality of the REMICs comprises a segregated pool of assets.

9. The method according to claim 1, wherein an indenture trustee administers the at least one REMIC.

10. The method of claim 4, wherein the REMIC certificates comprise multi-class securities.

11. The method of claim 10, wherein the multi-class securities comprise time-tranched securities.

12. A method for financing equity, the method comprising:
creating a first trust classifiable as a taxable mortgage pool (TMP);
acquiring at closing approximately 100% of the first trust certificates by at least one entity qualifying as a real estate investment trust (REIT), or as a qualified REIT subsidiary (QRS), within the meaning of Section 856(i) of the Internal Revenue Code of 1986 (Code);
defining at the closing at least one real estate mortgage investment conduit (REMIC) election;
upon occurrence of a TMP triggering event, which causes an issuing entity to become taxable as a corporation within the meaning of the Code, converting the first trust certificates to REMIC certificates pursuant to the at least one REMIC election defined at the closing;
transferring at least a portion of the first trust certificates to a second trust, wherein the at least one REMIC election is made in the second trust; and
issuing the REMIC certificates from the second trust.

13. The method as claimed in claim 12, wherein the converting of the first trust certificates to the REMIC certificates comprises:
taking possession by a lender of an equity held by the issuing entity and notifying the first trust;
notifying a master servicer of the taking of the possession by the lender;
buying out by the master service of Real Estate Owned (REO) property; and
notifying the first trust of the buying out; and
wherein the transferring of the portion of the first trust certificates to the second trust comprises:
transferring non-REO property to the second trust; and
making the at least one REMIC election within the second trust.

14. The method as claimed in claim 12, wherein the TMP triggering event comprises at least one of:
the at least one entity failing to qualify as a REIT after the closing;
an entire equity being transferred to a non-REIT entity, or to another non-qualifying entity; and
the equity being split so that at least a portion of the equity is transferred to a non-REIT entity, or to another non-qualifying entity.

15. The method as claimed in claim 12, further comprising issuing the REMIC certificates from the second trust.

16. The method as claimed in claim 12, further comprising making a plurality of REMICs elections.

17. The method as claimed in claim 15, wherein the REMIC certificates represent ownership of at least one of regular interests and residual interests.

18. The method as claimed in claim 16, wherein each of the plurality of the REMICs comprises a segregated pool of assets.

19. The method according to claim 12, wherein an indenture trustee administers the at least one REMIC.

20. The method of claim 15, wherein the REMIC certificates comprise multi-class securities.

21. The method of claim 20, wherein the multi-class securities comprise time-tranched securities.

22. A combination comprising:
a first trust classifiable as a taxable mortgage pool (TMP); and
at least one entity acquiring at closing approximately 100% of the first trust certificates, the at least one entity qualifying as a real estate investment trust (REIT), or as a qualified REIT subsidiary (QRS), within the meaning of Section 856(i) of the Internal Revenue Code of 1986 (Code);
wherein at least one real estate mortgage investment conduit (REMIC) election is defined at closing, and
upon occurrence of a TMP triggering event, which causes an issuing entity to become taxable as a corporation within the meaning of the Code, the first trust certificates are converted to REMIC certificates pursuant to the at least one REMIC election defined at the closing.

23. The combination as claimed in claim 22, further comprising an indenture trustee for administering the at least one REMIC.

24. The combination as claimed in claim 22, further comprising a second trust, wherein:
at least a portion of the owner trust certificates is transferred to the second trust;
the at least one REMIC election is made in the second trust; and
the REMIC certificates are issued from second new trust.

25. The combination as claimed in claim 22, wherein the REMIC certificates comprise multi-class securities.

26. The combination as claimed in claim 25, wherein the multi-class securities comprise time-tranched securities.
